(19) United States
(12) Patent Application Publication
(10) Pub. No.: US 2012/0054281 A1
(43) Pub. Date: Mar. 1, 2012

(54) System And Method For Enhancing Group Innovation Through Teambuilding, Idea Generation, And Collaboration In An Entity Via A Virtual Space

(75) Inventor: Barbara A. Westmoreland, Banner Elk, NC (US)

(73) Assignee: Intercenters, Inc., doing business as nTeams, Banner Elk, NC (US)

(21) Appl. No.: 12/870,132

(22) Filed: Aug. 27, 2010

(51) Int. Cl. G06F 15/16; G06G 7/48

(52) U.S. Cl. 709/205; 703/6

(57) ABSTRACT

A virtual space and/or instances thereof may be designed to facilitate enhanced performance of users associated with an entity in fulfilling roles and/or performing tasks for the entity. The virtual space may be designed to provide users with experiences that promote teamwork, coherence, and/or cohesiveness amongst a group of users; experiences that promote idea generation and/or creativity amongst a group of users; and/or, experiences that facilitate collaboration with internal and/or third party users that are external to the entity. The virtual space may be designed with separate areas to be used for different activities related to user interaction with people, ideas, data, documents, and/or objects separately. The activities to which the separate areas are dedicated may enhance innovation through teambuilding, idea generation, collaboration, and/or activities that provide other group benefits as compared to conventional techniques and systems.

### FIELD OF THE INVENTION

The invention relates to a virtual space for users associated with a specific entity to enhance group innovation by interacting with spatially separate areas for teambuilding, idea generation, and collaboration, and/or other activities that encourage users to work together to create solutions, services, and/or products.

### BACKGROUND OF THE INVENTION

Systems for providing virtual spaces to users are known. Some such systems have been leveraged by entities, such as businesses and educational institutions, to facilitate collaboration between employees, conduct training, and/or client meetings interactions. However, conventional systems that provide virtual spaces for users associated with specific entities may not be have spatially separated areas for different types of activities and/or interactions for the purpose of enhancing (or improving) the process of individual or group innovation. Further, the range of structured activities provided within the virtual spaces served by conventional systems may be limited.

### SUMMARY

One aspect of the invention relates to a virtual space and/or instances thereof designed to facilitate enhanced innovation of users associated with an entity in fulfilling roles (e.g., team roles and/or other roles) and/or performing tasks for the entity. The virtual space may be designed to provide users with experiences that promote teamwork, coherence, and/or cohesiveness amongst a group of users, experiences that promote idea generation and/or creativity amongst a group of users, and/or experiences that facilitate collaboration with internal and/or third party users that are external to the entity. The virtual space may be used as a business tool by a corporation, an educational institution, a charitable organization, a business, a government entity, and/or other entities. The virtual space may be used for employees, contractors, students, and/or other users associated with an entity to enhance performance of groups of users. The virtual space may be designed with separate areas to be used for different activities related to user interaction with people, ideas, data, documents, and/or objects separately. The activities to which the separate areas are dedicated may enhance innovation through teambuilding, idea generation, collaboration, and/or activities that provide other group benefits as compared to conventional techniques and systems.

The spatially distinct areas of the virtual space may be structured to support a process to enhance innovation in groups associated with the entity. The three spatially distinct areas of teambuilding, idea generation, and collaboration may contain activities, tools, and/or training that enhance the group capability to develop innovative solutions for the entity. The activities included in a teambuilding area may benefit the group by assisting them to leverage individual preferences and strengths, to create shared vision and values, to improve team coherence to establish an engaged, unified group culture that encourages and inspires innovation, and/or provide other benefits. The idea generation area may be configured to provide tools, activities, and/or training that may encourage groups to contribute innovative ideas through brainstorming, role playing, data modeling, 3D prototyping, and/or other activities throughout the group's work together. The collaboration area may include tools, activities, and/or training that may create an environment to share information and/or gather feedback that may improve the group and their internal and/or external partners capability to develop innovative solutions for the entity.

In some implementations, a system configured to serve the virtual space and/or instances thereof to users may include one or more servers and/or other components. The server may be configured to execute one or more of a space module, a security module, a registration module, an orientation module, a team building module, an idea generation module, a collaboration module, and/or other modules.

The space module may be configured to provide one or more instances of one or more virtual spaces to users via client platforms. The space module may be configured to operate in cooperation and/or coordination with one or more client platforms to provide an instance of a virtual space to users of the client platforms. For example, the space module may serve information to the client platforms such that views of the instance of the virtual space are presented to the users on the client platforms. Through the views of the virtual space presented to the users on the client platforms, the users may be able to interact with the virtual space and/or each other.

The security module may be configured to provide access selectively to instances of virtual spaces hosted by the space module. As has been mentioned above, the virtual spaces are configured to provide benefits to users associated with individual entities. Such entities may include one or more of a company, a division of a company, an academic institution, a department of an academic institution, a class, a charitable organization, a government agency, department or office, and/or other entities, or other groups of users. Individual virtual spaces (and/or instances thereof) may be configured specifically for particular entities or groups of users. The security module may be configured such that only users associated with an entity corresponding to an virtual space can access the virtual space. This may permit the virtual space (and/or instances thereof) to be customized for a specific entity and/or a group of users associated with the virtual space.

The registration module may be configured to register a new user or group of users to a virtual space. As such, the registration module may be configured to present to the new user an interface by which the user can create an avatar for the virtual space. The interface may be configured to receive selections and/or inputs by the user that specify features for the avatar. The features may include visible features of the avatar, skills or abilities of the avatar, virtual goods associated with the avatar (e.g., clothing), and/or other features of the avatar. The interface may be configured to receive selection from the user of a preconfigured avatar for use by the user. The preconfigured avatar may include an avatar available to new users and/or an avatar configured by the user for another virtual space.

The orientation module may be configured such that the virtual space includes an orientation area. The orientation area may include content that trains new users on how to use the virtual space. Such content may define one or more multi-media displays that demonstrate how to control an avatar, how to travel within the virtual space, how to interact with other users and/or other objects, and/or other aspects of user of the virtual space. The orientation module may be configured such that the orientation area includes one or more mechanisms for traveling to other areas in the virtual space. Such mechanisms may include one or more of paths, tunnels, or other routes to the different areas, one or more links or teleports to the different areas, directions (e.g., in the form of a map), and/or other modes of transportation for facilitating travel to other areas of the virtual space. In some implementations, the orientation area may be located in the sky above other areas of the virtual space. The orientation area may be a default initial area where avatars arrive responsive to users logging in whether they are new or previous users. The orientation area may be used exclusively for new users. Avatars under control of previous users may arrive at one or more other areas of the virtual space responsive to user login.

A virtual map of the virtual space may be included in views of the orientation space. One or more of the locations on the virtual map may be selectable by users (e.g., through a client platform) to cause avatars to travel to the areas in the virtual space depicted on the virtual map. Such travel may be accomplished via one or more of teleportation, flying, walking, running, boat, magic carpet, mount, and/or other means of transportation. The virtual map may indicate which direction avatars controlled by users should travel in order to reach the areas in the virtual space. The virtual map may provide other mechanisms and/or guidance for facilitating avatars controlled by users to reach the areas in the virtual space. In some implementations, the areas of the virtual space depicted on the virtual map may include one or more of an idea generation area, a collaboration area, a teambuilding area, and/or other areas. Discussion of a “map” is not intended to be limiting. Some other representation of the areas available to users within the virtual space may be included in views of the orientation space. For example, within the orientation space, a sign may bear a list of areas to which users (and/or the corresponding avatars) can be conveyed. The sign may not include cartographic information. The areas listed on the sign may be selectable for travel to a selected area.

The teambuilding module may be configured such that the virtual space includes a teambuilding area having content designed to facilitate teambuilding between users associated with the entity. In order to facilitate teambuilding, the teambuilding area may include virtual facilities for one or more teambuilding activities to be performed by avatars under the control of users, virtual facilities for communication between users before or after completing teambuilding activities, and/or other virtual facilities. For example, the teambuilding area may include one or more of an arrival section, one or more communication sections, a first activity section, a second activity section, a third activity section, a fourth activity section, a fifth activity section, and/or other sections. The communication section may include a first subsection, a second subsection, and/or other subsections.

The arrival section may be configured to receive avatars as they first arrive at the teambuilding area. From the arrival section, one or more of the other sections and/or subsections may be visible. For example, the arrival section may be elevated and may provide an overview of one or more of the other sections. As such, views of the arrival section may include distant views of one or more of the other sections, including other avatars performing the activities associated with the other sections and/or subsections. The arrival section may include a mechanism that facilitates avatar travel to other sections within the teambuilding area. For example, the mechanism may include one or more of a map, a selectable listing of sections, virtual means of travel (e.g., boat, plane, train, magic carpet, mount, and/or other means of travel), and/or other mechanisms.

The communication section may be configured to provide an environment in which activities performed in the teambuilding area can be discussed. The discussions may be held before activities are begun, during activities, and/or after activities are completed. Such discussions may include structured, formal discussions, unstructured, informal discussions, and/or other discussions. Aesthetically, the communication section may be represented in views of the teambuilding area as an environment in the real world in which conversations could be comfortably conducted. For example, the communication section may be represented in views of the teambuilding area as a lodge, sitting area, campfire, garden, and/or surrounding space.

The communication section may include a lodge, and may be configured for participation in informal conversations by users. The lodge may include spaces where avatars can sit, lounge, walk, talk, and/or otherwise perform activities commonly associated with informal discussions in the real world. The lodge may include sitting areas, a fireplace, and/or other comfortable aesthetic features. The lodge may also provide virtual facilities for conducting group training and/or discussions related to the virtual space and team building activities. For example, multimedia presentations may be available in the lodge with information about the teambuilding activities or other training topics, such as using various features and/or areas of the virtual space.

The communication section may be configured for more structured discussions of activities performed in the teambuilding area. By way of non-limiting example, communication section may include a subsection that is represented in views of the teambuilding area as a circle of objects on which avatars can be seated. The objects for seating avatars may be customizable by users and/or automatically based on individual preferences or strengths, performance in activities, to make points during discussion, and/or for other purposes. Views of the communication section may include features representing a real world environment conducive to communication. For example, the communication section may include one or more of a campfire, a garden, and/or other features conducive to group discussion or communication.

The first activity section, the second activity section, the third activity section, the fourth activity section, and/or the fifth activity section may be spatially separate within the teambuilding area, and may include content defining different team building activities to be performed by the avatars under control of a group of users.

For example, the first activity section may be configured for a group of avatars to travel through a path or other type of journey. Along the path, a plurality of crossroads may be presented to users controlling the avatars. At a given crossroads a plurality of potential paths for proceeding through the first activity section may be presented to users controlling the group of avatars. At a given crossroads, the choice of which path to take may be posed to the users controlling the avatars as a choice that may lead to a more effective attainment of some goal (e.g., getting through the first activity section fastest, acquiring some virtual good within the first activity section, and/or other goals). Information may be provided to users controlling the avatars while the avatars are at the given crossroads. This information may inform decisions of the users as to which path from the given crossroads their avatar will take. The information may be configured to distinguish different individual personality preferences, strengths, team roles, problem-solving styles, values, world views, and/or other distinctions between the ways in which users view the world and/or choices in their lives and in their group work.

Along the various paths through the first activity section, users controlling the avatars may be presented with content providing information to help them make better choices. Such information may include clues as to how a goal within the first activity section can be attained, directions for proceeding within the first activity section, and/or other information. As such, the path that one of the avatars takes through the first activity section may impact the information to which the user of the avatars may be exposed within the first activity section.

After the avatars have proceeded through the first activity section, and/or after some period of time within the first activity section, the avatars may be convened at a communication section. Views of the communication section presented to the users controlling the avatars may include, for example, a campfire. Within the communication section, users that have completed the activity of the first activity section may be led in a discussion of the choices they made along the paths of their avatars through the first activity section. The discussion may include reasons that individual users made their choices at the crossroads, the different information and/or lessons learned along the paths, the preferences that choices indicated about the individual users and/or the group of users as a whole, and/or other aspects of the activity.

During or after the communication section, users may obtain one or more virtual goods representing their choices within the first activity section. The virtual goods may represent choices of individual users and/or of the users as a group. For example, a set of virtual goods may be present in views of the communication section represented as sign posts displaying different animals that symbolize individual preferences and strengths. For example, a phoenix may symbolize the personality type of a user that finds a solution to emerge from a difficult situation. A turtle may symbolize the personality type of user who is methodical and deliberate at work. Other examples of symbols for individual preferences and strengths are contemplated. Users may select and/or be assigned one or more animal representations (or other symbolic representations) of strengths and/or preferences. The users may be provided with one or more virtual goods including the representation(s) they have been assigned or have selected. The virtual goods may be carried by the avatars being controlled by the users, maybe reflected in the attire of the avatars, be included in objects of the users, and/or otherwise received by the users.

The activity presented to users by the first section of the teambuilding area may improve group unity, the ability to work together to better find solutions by creating awareness, understanding, and/or respect for individual and team preferences, differences, and/or strengths. The teambuilding module may be configured such that the paths, the crossroads, the goals, the information along the paths, and/or other aspects of the first activity section may be customized to a specific entity and/or group of users associated with an entity. As such, the configuration of the first activity may be somewhat modular, thereby facilitating meaningful teambuilding interactions customized to a particular audience. The teambuilding module may be configured such that an activity in the first section of the teambuilding area may be repeated by a group. Such repetition may improve understanding and/or respect for individual and/or group preferences, differences, and/or strengths.

The teambuilding module may be configured such that standard tools and techniques used by entities to help individuals understand and apply their preferences and strengths to group work may be integrated into the first section of the teambuilding area. For example, one or more of Myers-Briggs personality-type indicators, Enneagrams, Belbin team roles, and/or other tools or techniques that may improve self and/or group awareness and leveraging of preferences and strengths may be integrated into the first activity area of the teambuilding section (and/or into the corresponding communication section).

The teambuilding module may be configured such that in the second activity section, a group of avatars are subjected to a common set of content. The common set of content may define a common and shared experiential environment for the group. The common experiential environment may include a path or journey along which the group of avatars may travel and/or be transported. For example, in views of the second activity section the avatars may appear to be conveyed along a waterway by way of watercraft (e.g., river raft, canoe, and/or other watercraft), or other type of transportation. At various points in the common experiential environment defined by the set of content (e.g., along the path or waterway), questions may be presented to users controlling the avatars. The users may be encouraged and/or required to answer the questions. Answers to the questions may be received via client platform, and/or kept locally by the users. Answers to the questions may be received via public texting, voice communications, and/or other mechanisms for communication.

The questions may be designed to facilitate identification of motivational drivers for engagement with the entity associated with the virtual space, for engagement with a project for the entity, for engagement with a group associated with the entity, and/or for other activities or roles. :As such, as the avatars proceed within the second activity section in answering the: questions, individual users and/or the group may recognize their motivation for engaging in an activity or role associated with the entity, create a motivating vision of the future of an activity or role associated with the entity, define criteria for individual and/or group success, inspire individuals and/or groups to strive to achieve success, and/or receive other personal and group benefits. This activity may be repeated to refine, change, or reinforce individual or group motivations and/or visions of success.

The teambuilding modulemay be configured such that the questions are modular, and separate from the set of content. As such, the second activity section may be customized for an entity, a specific group of users, a specific user, and/or other groups or users by simply replacing or adjusting the questions and leaving unchanged the common experiential environment defined by the set of content through which avatars proceed.

Subsequent to the avatars proceeding through the journey defined by the set of content in the second activity section, the avatars may be convened at a communication section of the teambuilding area. In the communication section, the users controlling the avatars that proceeded through the second activity section may be encouraged to discuss their answers to the questions. The discussion may include the development of an individual and/or shared team vision, a group goal or objective, and/or other group-based or individual concepts.

The teambuilding module may be configured such that the third activity section comprises a task or goal to be achieved by a group of avatars. The task or goal may include overcoming one or more obstacles. By way of non-limiting example, within the third activity section, the group of avatars may be challenged to traverse, within the virtual space, a rushing river to find a rare article of flora or fauna (e.g., a bristled pinecone), to traverse, within the virtual space, a rickety or unstable bridge to find a rare article of flora or fauna (e.g., a specific bird feather), to hike up, within the virtual space, an icy mountain to locate a rare mineral (e.g., a valuable gem), and/or other tasks with defined goals and objectives.

The teambuilding module may be configured such that prior to beginning the task with defined objectives, the users controlling the group of avatars obtain a set of values. The set of values may include one or more values selected by the users, one or more values assigned to the users, and/or one or more values obtained in different ways. Some non-limiting examples of values may include one or more of teamwork, trust, collaboration, winning, efficiency, customer service, and/or other values. The users may be required to adhere to the obtained set of values during performance of the task or objective. When faced with obstacles or challenges, the users may be required to make decisions in alignment with the values in the obtained set of values while controlling their avatars. Individual and/or group decisions about how to achieve their objective may be impacted based on the values that they are provided. By varying the set of values obtained by a group of users, the objectives or tasks provided in the second activity section may be repeated numerous times without yielding the same experience. Each time the group of users participate in the second activity section, they may gain an understanding of the challenges and difficulties of a group making value-based decisions when faced with obstacles and pressures to succeed.

The teambuilding module may be configured such that before, after, or as the group completes an objective or task in the third activity section, the group of avatars may be convened in the fourth activity section. Views of the fourth activity section presented to the users controlling the avatars may include a set of objects that correspond to individual avatars in the group. The objects may be configured such that the avatars can sit, stand, recline, or otherwise dwell on or in them, or the objects may be provided separately from objects on which the avatars can sit, stand, recline or otherwise dwell. The views of the fourth activity section may include a group object.

In fourth activity section, users controlling the avatars may be presented with a set of values. The values presented may include values assigned to the group during participation in the task or object of the second activity section, and/or other values (e.g., values selected by the entity). Selections by the users of individual values from the set of values may be elicited and/or received. Responsive to such selection, the objects associated with individual users may be customized to reflect the values selected by the users. Since the selection takes place following participation in completing the objective or task of the second activity section, the users may be particularly attuned to the meaning and/or challenges of making value-based decisions. The recent experience of the second activity section may inform decisions of the users in selecting values from the set of values.

In fourth activity section, the users controlling the avatars may be encouraged to discuss their individual selection of values. The reflections of the selected values in the objects corresponding to the individual users may serve to direct the conversation and/or hold the attention of users to listen to and learn from other users about their own selections. This appreciation for differences in individual user's values may enhance team unity and ability to work together to create innovative solutions. In some implementations, one or more virtual goods associated with selections of values made in the fourth activity section may be provided to the users for use elsewhere in the virtual space.

In the fourth activity section, the users may collectively select values for the group. As the users select and/or deselect values for inclusion in their collective set of values, the group object may be dynamically adjusted to reflect the choices. For example, the group object may include a statue that is adjusted based on the selection of values for the group. Upon selection of a set of group values, virtual goods reflecting the final status of the group object may be distributed to individual users in the group. Virtual goods reflecting the final status of the group object may be displayed in views of other areas of the virtual space (e.g., the lodge, the idea generation area, and/or the collaboration area) as a reminder of the group values.

The selection and discussion of individual and group values may facilitate understanding and/or respect between the users. Such understanding may include appreciation of how age, gender, culture, and/or life experience may impact individual values and/or decision-making. The understanding facilitated and/or fostered within fourth section may enhance value-based decision-making by the group as they work together on projects and/or find solutions to problems.

The teambuilding module may be configured such that in the fifth activity section a task is to be performed by an individual avatar from a group of avatars, or by a subset of the avatars in the group of avatars. In views of the fifth activity section presented to users controlling the avatars performing the task, the other avatars in the group may be visible. The environment and conditions surrounding the task may be designed to create stress in the user(s) performing the task. For example, the task may be timed or limited by other external conditions to increase difficulty in performing the task. The task may be represented in views of the fifth activity section as being performed underwater so that the avatar must perform the task before running out of air, time, and/or other resources.

The teambuilding module may be configured such that users controlling avatars not performing the task may be assigned different types of responses to the performance of the task. The responses may be the same or different for the individual avatars not performing the task. The responses may include, for example, supportive or encouraging, unsupportive or discouraging, non-expressive, and/or other types of responses. The users controlling the avatars not performing the task may be instructed to control their avatars to express the assigned responses. In some implementations, the avatars not performing the task may be controlled automatically by the teambuilding module to express the assigned responses. Since the avatars not performing the task may be present in views of the fifth activity section presented to the user controlling the avatar performing the task, perceived responses of group members during performance of the task may impact the ability of the user controlling the avatar to perform the task.

The teambuilding module may be configured such that the fifth activity section may be designed to provide a plurality of tasks and/or difficulty levels. By varying the task, the difficulty level, and/or the responses of the non-performing avatars, the activities of the fifth activity section may be repeated multiple times while still providing new experiences that build group unity, support, and/or coherence throughout the group's work.

The teambuilding module may be configured such that subsequent to completion of the fifth activity section, the group of avatars may be convened in a communication section. In the communication section, the users controlling the group of avatars may be lead in a discussion of the impact of the observing avatars on the user(s) controlling the avatar(s) performing the task(s) of the fifth activity section. Training on ways to alleviate the stress of individual performance and techniques to achieve group coherence may also be presented to the group. Tools and/or techniques may be presented to the group that may alleviate stress. Such tools and/or techniques may include one or more of biofeedback tools and/or technology, breathing techniques, visualization, meditation, and/or other tools and/or techniques to help individual and/or groups monitor and enhance coherence. Tools and/or techniques may be modified based on the preferences, tools, and/or requirements of the entity.

The group training and discussion may facilitate understanding by the users of the impact of group support on stress and individual and team performance. This understanding and use of tools and/or techniques to alleviate stress may enhance group unity, coherence, and/or performance by the group in working to solve problems and/or tasks in the future.

The teambuilding module may be configured such that other teambuilding experiences, activities, and/or tools may be added to the teambuilding area based on entity preferences, tools, and/or requirements.

The idea generation module may be configured such that the virtual space comprises an idea generation area that includes content designed to facilitate cooperative generation, capture, selection, prioritization, tracking, and/or inventory, of ideas by individuals and/or groups of users. This content may include creativity tools and/or activities. The idea generation area may be designed to facilitate idea generation for solutions that benefit the entity. For example, the idea generation area may be designed to facilitate generation of ideas for solutions to improve client services, organizational development, product development, and/or other internal and/or external product and service solutions related to the entity. The idea generation module may be configured such that the idea generation area may be restricted to be viewable only to users associated with the entity and/or to third party users external to the entity. In some implementations, the idea generation module may be configured such that the idea generation area, a section of the idea generation area, and/or an instance of the idea generation area may be restricted to a predetermined set of users. The predetermined set of users may include users associated with the entity and/or users external to the entity. In such implementations, the idea generation module may cooperate with the security module to ensure that unauthorized users are not provided with views, sounds, and/or other media associated with the restricted area, section and/or instance.

The idea generation module may be configured such that the idea generation area comprises a plurality of separate sections configured with tools and/or activities to facilitate different types of creative thinking in order to generate innovative ideas. In some implementations, the idea generation area may include one or more of a first section, a second section, a third section, a fourth section, and/or other sections.

The idea generation module may be configured such that the first section of the idea generation area includes content configured to facilitate brainstorming by individuals and/or a group of users. The content may include scenery, tools, activities, characters, documents, photos, objects, and/or other content. For example, the first section may include brainstorming tools to display visual representations of ideas generated by users. The visual representations may be visible in views of the first section as one or more surfaces that display text and/or markings generated by one or more users. The one or more surfaces may be represented in views of the first section as real world surfaces that traditionally display text and/or markings as part of a brainstorming process. For example, the one or more surfaces may be represented as one or more of a sticky note (e.g., having a user selectable color), a white board, a chalk board, note paper, and/or other surfaces. One or more aspects of the text or markings generated by users may be selectable by users. For example, the font, color, highlighting, size, spacing, and/or other aspects of the text or markings may be selectable by users. In the first section, the one or more surfaces may be clearly visible in views of the first section so as to share the text and/or markings with all (or substantially all) users viewing views of the first section.

The first section may be integrated with one or more applications designed to facilitate idea generation, capture, selection, prioritization, tracking, and/or inventory. Such tools may include, for example the tools provided Brightidea®, the tools provided by Mindmap®, and/or other tools. Ideas generated within the first section may be captured by saving text or markings generated by users, recording voice communications, storing files created with tools integrated with the first section, and/or storing files capturing ideas conceived or expressed within the first section.

The idea generation module may be configured such that the second section of the idea generation area, separate from the first section of the idea generation area, has different content designed to facilitate cooperative generation of ideas by individuals and/or groups of users through role-playing and/or simulation. The content may include scenery, tools, activities, characters, documents, photos, objects, and/or other content. Such content may define a virtual venue configured for simulations of real world interactions by avatars. The simulations may be performed by avatars under the control of users. The venue may be viewable (and heard), along with avatars performing simulations therein, in views of the second section.

The venue may comprise a portion of the second section that is visibly prominent in views of the second section. The visible prominent portion of the second section may be configured for the performance of simulations therein. The venue may be represented in views of the second section having features of real world venues for performance of sales and/or customer interactions, employee interactions, awards ceremonies, demonstrations, shows, and/or other simulations of interactions. For example, the prominent portion of the second section may be represented in views of the second section as a stage.

In some implementations, the venue in the second section may be represented in views of the second section as a simulated environment similar to a real world environment in which people would interact on matters related to the entity. For example, the second section may be represented as an office, a retail environment, a worksite, and/or other environments simulating the real world. The second section may be integrated or usable with one or more tools or applications designed to facilitate idea generation, capture, selection, prioritization, tracking, and/or inventory during or after simulations or role plays.

The idea generation module may be further configured such that the venue includes seating for avatars controlled by users observing a simulation or role play. Such seating may include one or more objects upon which avatars under the control of users can sit. The objects may be arranged in the second section such that the prominent portion of the second section is present in views of the second section having points of view that correspond to the objects (e.g., the prominent portion may be viewable by avatars sitting on the objects). The objects may be represented in views of the second section as chairs, benches, cushions, and/or other objects.

Simulations and/or role plays performed in the second section may be recorded and stored. Stored simulations may be used for demonstration or training within the virtual space and/or outside of the virtual space.

The idea generation module may be configured such that a third section of the idea generation area, separate from the first section and the second section, has different content designed to facilitate cooperative generation of ideas by users. The content may include scenery, tools, activities, characters, documents, photos, objectives, and/or other content. The third section may be designed to facilitate visualization of prototypes and/or their operation. As such, the idea generation module may be configured to provide users with controls for creating virtual design prototypes. The virtual design prototypes may include three-dimensional prototypes of products, buildings, operational devices, and/or other objects. The controls may be configured to receive input from the users related to the size, orientation, shape, color, mobility, operability, and/or other aspects of components of the virtual prototypes. The controls may be configured to receive selections of pre-existing objects, modifications to pre-existing objects, creation of new objects, and/or other selections facilitating creation of virtual prototypes. Pre-existing objects may include objects created within the virtual space, and/or objects created using other applications and/or platforms and imported to the virtual space (e.g., CAD/CAM objects, and/or other objects). The third section may be integrated or usable with one or more tools or applications designed to facilitate idea generation, capture, selection, prioritization, tracking, and/or inventory during prototype modeling.

The idea generation module may be configured such that a fourth section of the idea generation area, separate from the first section, the second section and the third section, has different content designed to facilitate cooperative generation of ideas by individuals and/or groups of users. The fourth section of the idea generation area may be configured to facilitate three dimensional data visualization. As such, the idea generation module may be configured to receive multi-dimensional data (e.g., from a spreadsheet file), and to generate a three-dimensional representation of the data. The idea generation module may be configured to receive selection and/or input by users of adjustments, additions, deletions, and/or other alterations of the data. Alteration of the data by users may result in adjustment of the three-dimensional representation of the data. The fourth section may be integrated or usable with one or more tools or applications designed to facilitate idea generation, capture, selection, prioritization, tracking, and/or inventory during or after data visualization.

By providing the first, second, third, fourth, and/or other sections separately, the idea generation module may spatially separate different creative activities associated with finding solutions benefiting the entity. This spatial separation may enhance creativity, organize group and/or individual creativity and/or thought, and/or provide other enhancements.

The idea generation module may be configured such that other group idea generation experiences, activities, and/or tools may be added to the idea generation area based on entity preferences, tools, and/or requirements.

The collaboration module may be configured such that the virtual space includes a collaboration area with content designed to facilitate interaction between internal users associated with the entity, external third party users, and/or other visitors. Third party users or visitors may refer to users that do not have access to one or more other areas of the virtual space (e.g., the idea generation area, the teambuilding area, etc.). Such users may not have access to the one or more other areas because they are not directly associated with the entity corresponding to the virtual space. For example, such users may be business partners of the entity (and/or of users associated with the entity), guests of the entity (and/or of users associated with the entity), clients or potential clients of the entity (and/or of users associated with the entity, and/or other third party users or visitors.

The collaboration module may be configured such that the collaboration area comprises one or more public sections and/or one or more private sections. The collaboration area may be arranged such that interactions between users controlling avatars (or otherwise being present) in a public section may be observable or heard to other users in views of the public section. The collaboration area may be arranged such that interactions between users controlling avatars (or otherwise being present) in a private section may only be observable to and heard by a predefined group of users. The predefined group of users may be the group of users controlling avatars (or otherwise being present) in the private section.

One of the private sections may function as a virtual private room in which content displayed, noises generated, and/or other exchanges of information and/or ideas are contained to views presented to users controlling avatars within the private section. Entry of avatars to the private section may be controlled by a user or set of users. The public section, on the other hand may be open to all users that obtain entry to the collaboration area. Although the public section may include objects that obstruct views of the public section, by maneuvering an avatar and/or a point of view within the public section a user may be able to gain access to interactions or activities transpiring within the public section. The presence of the private sections within the collaboration area may provide a mechanism within the virtual space for including business partners, clients or potential clients, and/or other users not associated with the entity in private use of the three dimensional immersive environment of the virtual space. Aesthetically, the public and private sections may be represented in views of the collaboration area as conference rooms, pods, booths, lofts, and/or other public or private areas. These areas may include content such as scenery, tables, chairs, lighting, multi-media displays, branding and logos and other objects associated with public and private collaboration areas.

The collaboration module may be configured such that the public or private sections include tools for presenting ideas, proposals, and/or other content generated by users. Such tools may be implemented to create such content in real-time and/or to present content that has been previously created (e.g., word processing files, websites, video files, application data, spreadsheet files, presentation files, and/or other content).

The collaboration module may be configured such that other collaboration experiences, activities, and/or tools may be added to the collaboration area based on entity preferences, tools, and/or requirements.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system 10 configured to provide instances of one or more virtual spaces to users associated with specific entities, in accordance with one or more embodiments of the invention.

FIG. 2 illustrates a virtual map of a virtual space, in accordance with one or more embodiments of the invention.

FIG. 3 illustrates a map of a teambuilding area of a virtual space, according to one or more embodiments of the invention.

FIG. 4 illustrates a map of an activity section of a teambuilding area of a virtual space, in accordance with one or more embodiments of the invention.

FIG. 5 illustrates a view of a communication section of a teambuilding area of a virtual space, according to one or more embodiments of the invention.

FIG. 6 illustrates a view of an activity section of a teambuilding area of a virtual space, in accordance with one or more embodiments of the invention.

FIG. 7 illustrates a view of an activity section of a teambuilding area of a virtual space, in accordance with one or more embodiments of the invention.

FIG. 8 illustrates a map of an idea generation area in a virtual space, according to one or more embodiments of the invention.

FIG. 9 illustrates a view of a section of an idea generation area of a virtual space, in accordance with one or more embodiments of the invention.

FIG. 10 illustrates a view of a section of an idea generation area of a virtual space, in accordance with one or more embodiments of the invention.

FIG. 11 illustrates a map of a collaboration area made up of a public section and a plurality of private sections, according to one or more embodiments of the invention.

FIG. 12 illustrates a method of providing a virtual space to users associated with a real world entity, according to one or more embodiments of the invention.

FIG. 13 illustrates a method of providing a teambuilding activity in a virtual space to users associated with a real world entity, according to one or more embodiments of the invention.

FIG. 14 illustrates a method of providing a teambuilding activity in a virtual space to users associated with a real world entity, according to one or more embodiments of the invention.

FIG. 15 illustrates a method of providing a teambuilding activity in a virtual space to users associated with a real world entity, according to one or more embodiments of the invention.

FIG. 16 illustrates a method of providing a teambuilding activity in a virtual space to users associated with a real world entity, according to one or more embodiments of the invention.

FIG. 17 illustrates a method of providing a teambuilding activity in a virtual space to users associated with a real world entity, according to one or more embodiments of the invention.

### DETAILED DESCRIPTION

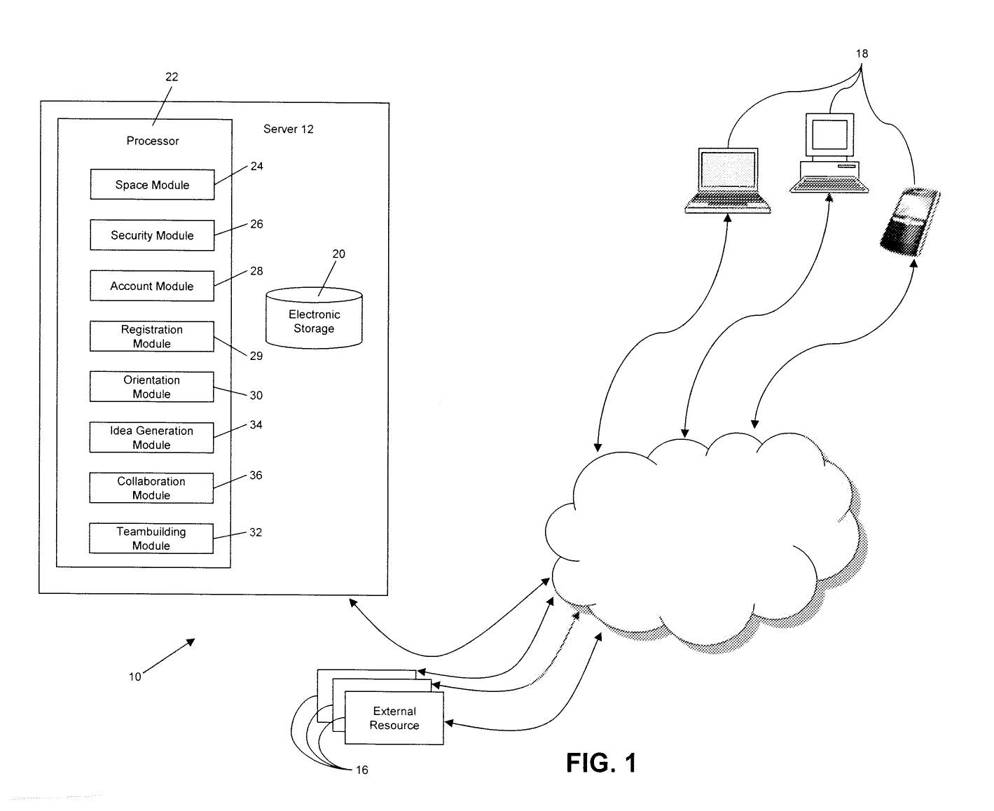

FIG. 1 illustrates a system 10 configured to provide instances of one or more virtual spaces to users associated with specific entities. The system 10 is configured such that the virtual spaces have content therein designed to enhance innovation of groups of users. The content may be designed to enhance teamwork, coherence, and/or cohesiveness amongst groups of users, foster idea generation and creativity amongst groups of users, facilitate collaboration between internal users and/or external third party users of an entity, and/or provide other functionality. The virtual spaces may include separate areas dedicated to different activities related to user interaction and/or performance. The activities to which the separate areas are dedicated may provide for enhanced teambuilding, idea generation, collaboration, and/or have other enhancements over conventional techniques and systems.

In some implementations, system 10 may include one or more servers 12 and/or other components. The system 10 may operate in communication and/or coordination with one or more external resources 16. Users may interface with system 10 and/or external resources 16 via client platforms 18. The components of system 10, servers 12, external resources 16, and/or client platforms 18 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 12, external resources 16, and/or client platforms 18 are operatively linked via some other communication media.

A given client platform 18 may include one or more processors configured to execute computer program modules (not shown). The computer program modules may be configured to enable one or more users associated with the given client platform 18 to interface with system 10 and/or external resources 16, and/or provide other functionality attributed herein to client platforms 18. By way of non-limiting example, the given client platform 18 may include one or more of a desktop computer, a laptop computer, a handheld computer, a NetBook, a Smartphone, a touch-based tablet, a television, and/or other client platforms.

The external resources 16 may include sources of information, hosts and/or providers of virtual environments outside of system 10, external entities participating with system 10, and/or other resources. By way of non-limiting example, external resources 16 may include one or more of an Internet information source, an application server, a document management server, and/or other resources. In some implementations, some or all of the functionality attributed herein to external resources 16 may be provided by resources included in system 10.

The servers 12 may include electronic storage 20, one or more processors 22, and/or other components. The servers 12 may include communication lines, or ports to enable the exchange of information with a network and/or other computing platforms. In some implementations, a firewall (not shown) may be included in system 10 between client platforms 18 and servers 12. The firewall may be configured to secure access of servers 12 to authorized users. Further, access to specific functionality at servers 12 may be governed on a per-user basis, a per-group basis, a per-entity basis, and/or on other basis. The firewall may be a piece of hardware that is physically separate from servers 12, and/or may be implemented in the same hardware as servers 12.

Electronic storage 20 may comprise electronic storage media that electronically stores information. The electronic storage media of electronic storage 20 may include one or both of system storage that is provided integrally (i.e., substantially non-removable) with servers 12 and/or removable storage that is removably connectable to servers 12 via, for example, a port (e.g., a USB port, a firewire port, etc.) or a drive (e.g., a disk drive, etc.). Electronic storage 20 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 20 may store software algorithms, information determined by processor 22, information received from client platforms 18, and/or other information that enables servers 12 to function properly.

Processor(s) 22 is configured to provide information processing capabilities in servers 12. As such, processor 22 may include one or more of a digital processor, an analog processor, a digital circuit designed to process information, an analog circuit designed to process information, a state machine, and/or other mechanisms for electronically processing information. Although processor 22 is shown in FIG. 1 as a single entity, this is for illustrative purposes only. In some implementations, processor 22 may include a plurality of processing units. These processing units may be physically located within the same device, or processor 22 may represent processing functionality of a plurality of devices operating in coordination.

As is shown in FIG. 1, processor 22 may be configured to execute one or more computer program modules. The one or more computer program modules may include one or more of a space module 24, a security module 26, an account module 28, a registration module 29, an orientation module 30, a teambuilding module 32, an idea generation module 34, a collaboration module 36, and/or other modules. Processor 28 may be configured to execute modules 24, 26, 28, 29, 30, 32, 34, and/or 36 by software; hardware; firmware; some combination of software, hardware, and/or firmware; and/or other mechanisms for configuring processing capabilities on processor 22.

It should be appreciated that although modules 24, 26, 28, 29, 30, 32, 34, and 36 are illustrated in FIG. 1 as being co-located within a single processing unit, in implementations in which processor 22 includes multiple processing units, one or more of modules 24, 26, 28, 29, 30, 32, 34, and/or 36 may be located remotely from the other modules. For example, some or all of the functionality attributed below to one or more of modules 24, 26, 28, 29, 30, 32, 34, and/or 36 may be provided by one of client platforms 18, and/or may be facilitated, enabled, and/or enhanced by one of client platforms 18. The description of the functionality provided by the different modules 24, 26, 28, 29, 30, 32, 34, and/or 36 described below is for illustrative purposes, and is not intended to be limiting, as any of modules 24, 26, 28, 29, 30, 32, 34, and/or 36 may provide more or less functionality than is described. For example, one or more of modules 24, 26, 28, 29, 30, 32, 34, and/or 36 may be eliminated, and some or all of its functionality may be provided by other ones of modules 24, 26, 28, 29, 30, 32, 34, and/or 36. As another example, processor 22 may be configured to execute one or more additional modules that may perform some or all of the functionality attributed below to one of modules 24, 26, 28, 29, 30, 32, 34, and/or 36.

The space module 24 may be configured to provide one or more instances of one or more virtual spaces to users via client platforms 18. As used herein, a virtual space may comprise a simulated space (e.g., a physical space) instanced on a server (e.g., servers 12) that is accessible by a client (e.g., client platforms 18) located remotely from the server to format a view of the virtual space for display to a user. The simulated space may have a topography, express ongoing real-time interaction by the user, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, collision, other physics characteristics, a landscape, and/or other aspects).

The space module 24 may be configured to provide an instance of a virtual space to users of client platforms 18 by serving information to client platforms 18 such that views of the instance of the virtual space are presented to the users on the client platforms 18. The views may include two-dimensional views and/or three-dimensional views. The client platforms 18 may execute a client application that implements the information served from space module 24 to present the views of the instance of the virtual space for display on client platforms 18. Presenting the views may include rendering the views locally on client platforms 18, and/or streaming previously rendered views. The client application may be an application that is dedicated to a particular virtual space platform and/or an application configured to generate views of other virtual environments (e.g., a web browser client, and/or other client applications).

An “instance” of a virtual space may refer to an individual space. Multiple instances of a given virtual space may be generated and provided to users simultaneously (e.g., by the same server and/or by separate servers). Generally, users accessing a first instance of a virtual space may be able to interact with each other. Users accessing a second instance of the virtual space may be unable to interact with the users accessing the first instance of the virtual space. Similarly, interactions of one user with the first instance may be observable to another user accessing the first instance, but unobservable to a user accessing the second instance. In some implementations, individual areas within an instance of a virtual space may be instanced. For example, an area corresponding to a given activity may be limited to a certain number of users. To enable other users to participate in the given activity after capacity has been reached for one round of the given activity for a first user group, space module 24 may be configured to generate another instance of the area to permit a second user group to participate in the given activity before the first user has completed the given activity.

Within a virtual space provided by virtual environment servers 12, avatars associated with the users may be controlled by the users to interact with each other and/or the virtual space. As used herein, the term “avatar” may refer to an object (or group of objects) present in the virtual space that represents an individual user. The avatar may be controlled by the user with which it is associated. The avatars may interact with each other by physical interaction within the instanced virtual space, through text chat, through voice chat, and/or through other interactions. The avatar associated with a given user may be created and/or customized by the given user. The avatar may be associated with an “inventory” of virtual goods and/or currency that the user can use (e.g., by manipulation of the avatar and/or the items) within the virtual space.

The views of the virtual space provided to a user via one of client platforms 18 may correspond to the position of the avatar associated with the user. For example, the views may be generated from a point of view associated with the position of the avatar. The point of view may vary as a function of the location of the avatar in the virtual space, the orientation of the avatar in the virtual space, and/or other parameters related to the position of the avatar in the virtual space. Some examples of different points of view include first person, third person, and/or other points of view. In some implementations, space module 24 may be configured to receive controls from a user to control the point of view of the views being displayed to the user separate from movement and/or position of the avatar under control of the user.

Virtual goods may be non-physical objects that can be purchased for use in online communities, online games, virtual worlds, and other virtual spaces. Virtual goods may include, for example, such things as digital gifts, digital clothing for avatars, virtual real estate, virtual weapons, mounts, vehicles, icons, tokens, and/or any other virtual item. Virtual goods may be classified as services (i.e., virtual services) instead of goods.

The security module 26 may be configured to provide access selectively to instances of virtual spaces hosted by space module 24. As has been mentioned above, the virtual spaces are configured to provide benefits to users associated with individual entities. Such entities may include one or more of a company, a division of a company, an academic institution, a department of an academic institution, a class, a charitable organization, a government entity, department or office, and/or other entities, or other groups of users. Individual virtual spaces (and/or instances thereof) may be configured specifically for particular entities or groups of users. The security module 26 may be configured such that only users associated with an entity corresponding to a virtual space can access the virtual space. This may permit the virtual space (and/or instances thereof) to be customized for a specific entity and/or a group of associated users.

For example, security module 26 may be configured to only provide access to the instance of the virtual space upon receiving security information from a user via client platform 18. The security information may include information that is specific to the user. Such information may include real world identification (e.g., name, employee ID, membership ID, and/or other information), a user password, and/or other user specific security information. The security information may include information that is specific to entity that corresponds to the instance of the virtual space. Such information may include entity identification information, an entity password, and/or other entity specific security information.

In some implementations, the information required by security module 26 may be different the first time a user requests access to the virtual space than information required for subsequent requests. For example, the first time a user requests access to the virtual space, security module 26 may request information that is entity specific. Responsive to receiving appropriate entity specific information, security module 26 may prompt the user to create a user account (discussed further below), including the establishment of user specific security information. In subsequent requests, the user may provide the user specific security information to obtain access to the virtual space. As another example, the first time a user requests access to the virtual space, security module 26 may request information that is user specific, but is only temporary. Responsive to receiving temporary securing information from the user, security module 26 may prompt the user to create a user account with user specific security information for use in future requests.

The security module 26 may be configured to disseminate invitations to an entity specific virtual space. The invitation may include preliminary or single-use security information associated with an entity that is to be given access to an entity-specific virtual space. To accomplish this, security module 26 may be configured to receive a set of users associated with the entity via one of client platform 18. The set of users may indicate a mechanism for contacting the users. Such a mechanism may include one or more of phone number, email address, real world address, and/or other mechanisms for contacting users. The security module 26 may be configured to contact the users to provide them with the invitations. In some implementations, security module 26 may be configured to generate the invitations for dissemination by the entity (and/or agents thereof).

The account module 28 may be configured to manage user accounts of the users of system 10. The one or more user accounts may include information stored by electronic storage 20, one or more of the client platforms 18, and/or other storage locations. The user accounts may include, for example, information identifying users (e.g., a username or handle, a number, an identifier, and/or other identifying information) within a virtual space provided by space module 24, security information (e.g., used by security module 26), subscription information, virtual currency account information (e.g., related to currency held in credit for a user), friend information (e.g., information related to friends of a user), virtual space usage information, demographic information associated with users, interaction history among users in virtual spaces, information stated by users, purchase information of users, browsing history of users, a client platform identification associated with a user, a phone number associated with a user, and/or other information related to users.

The information included in the user accounts may include virtual goods inventories of the users. As such, account module 28 may be configured to track virtual goods associated with users of the virtual space(s). Such virtual goods may or may not be visible in a virtual space, in various implementations. This visibility and/or invisibility may be configurable by the user associated with the virtual goods. The virtual goods may include non-physical objects that are expressible within the virtual space(s). The virtual goods associated with an individual user may include one or more of virtual clothing, virtual weapons, virtual vehicles, virtual pets, virtual toys, virtual tools, virtual gifts, mounts, virtual vehicles, icons, tokens, and/or other virtual goods. The virtual goods associated with an individual user may include goods that are visible within the virtual space(s). Such virtual goods may or may not enhance the abilities, skills, and/or gameplay of the user with which they are associated. The virtual goods associated with an individual user may include one or more of virtual goods the user is currently using, virtual goods the user is currently carrying, virtual goods the user has access to, and/or other virtual goods associated with the user.

The registration module 29 may be configured to register a new user or group of users to a virtual space hosted by space module 24 (and/or an instance thereof). As such, orientation registration module 29 may be configured to present to the new user an interface by which the user can create an avatar for the virtual space. The space module 24 may be configured to provide the interface to the user via client platform 18. The interface may be configured to receive selections and/or inputs by the user that specify features for the avatar. The features may include visible features of the avatar, skills or abilities of the avatar, virtual goods associated with the avatar (e.g., clothing), and/or other features of the avatar. The interface may be configured to receive selection from the user of a preconfigured avatar for use by the user. The preconfigured avatar may include an avatar available to new users and/or an avatar configured by the user for another virtual space.

The orientation module 30 may be configured such that the virtual space includes an orientation area. The orientation area may include content that trains new users on how to use the virtual space. Such content may define one or more multi-media displays that demonstrate how to control an avatar, how to travel within the virtual space, how to interact with other users and/or other objects, and/or other aspects of user of the virtual space. The orientation module 30 may be configured such that the orientation area includes one or more modes of travel for traveling to other areas in the virtual space. Such mechanisms may include one or more of paths, tunnels, or other routes to the different areas, one or more links or teleports to the different areas, directions (e.g., in the form of a map), and/or other mechanisms for facilitating travel to other areas of the virtual space. In some implementations, the orientation area may be located in the sky above other areas of the virtual space. The orientation area may be a default initial area where avatars arrive responsive to users logging in whether they are new or old. The orientation area may be used exclusively for new users. Avatars under control of previous users may arrive at one or more other areas of the virtual space responsive to user login.

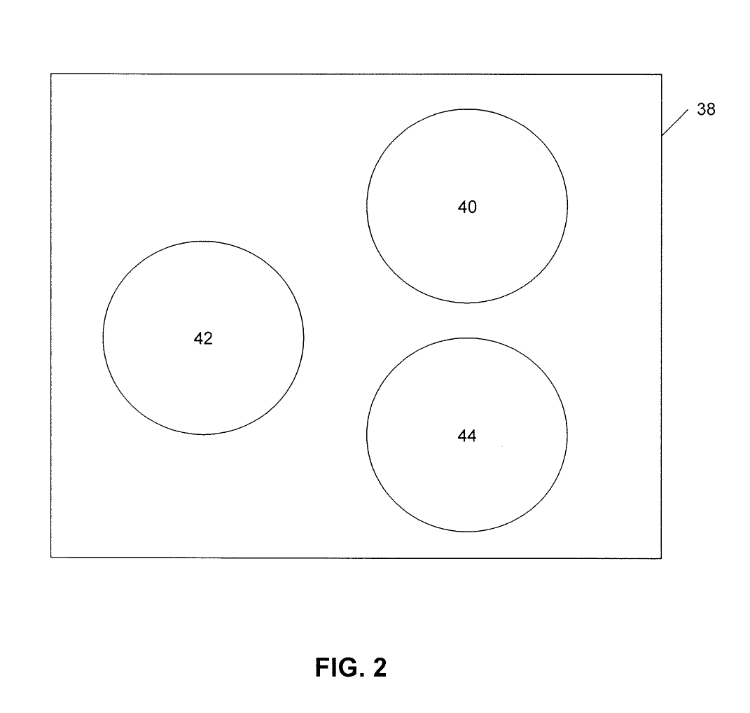

FIG. 2 illustrates a virtual map 38 of the virtual space. The virtual map 38 of the virtual space may be included in views of the orientation space. One or more of the locations on virtual map 38 may be selectable by users (e.g., through a client platform) to cause avatars to travel to the areas in the virtual space depicted on virtual map 38. Such travel may be accomplished via one or more of teleportation, flying walking running, boat, magic carpet, mount, and/or other means of transportation. The virtual map 38 may indicate which direction avatars controlled by users should travel in order to reach the areas in the virtual space. The virtual map 38 may provide other mechanisms and/or guidance for facilitating avatars controlled by users to reach the areas in the virtual space. In some implementations, the areas of the virtual space depicted on virtual map 38 may include one or more of a teambuilding area 40, an idea generation area 42, a collaboration area 44, and/or other areas. Virtual map 38 is provided as merely an example of providing information to users in the orientation area related to the spatial layout of the virtual space. Other examples that could be presented to users in views of the orientation area may include a sign bearing a list of areas to which users (and/or the corresponding avatars) can be transported. The sign may not include cartographic information about the areas. The areas listed on the sign may be selectable for travel to a selected area.

Returning to FIG. 1, the teambuilding module 32 may be configured such that the virtual space includes a teambuilding area having content therein designed to facilitate teambuilding between users associated with the entity. In order to facilitate teambuilding, the teambuilding area may include virtual facilities for one or more teambuilding activities to be performed by avatars under the control of users, virtual facilities for communication between users regarding completed teambuilding activities, and/or other virtual facilities.

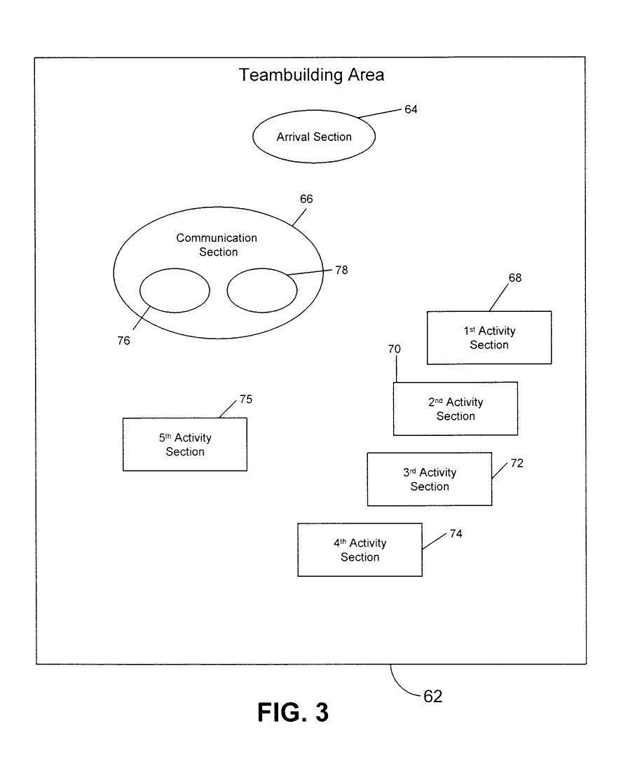

By way of illustration, FIG. 3 depicts a map 62 of a teambuilding area of the virtual space. The teambuilding area may include one or more of an arrival section 64, a communication section 66, a first activity section 68, a second activity section 70, a third activity section 72, a fourth activity section 74, a fifth activity section 75, and/or other sections. The communication section 66 may include a first subsection 76, a second subsection 78, and/or other subsections.

The arrival section 64 may be configured to receive avatars as they first arrive at the teambuilding area. The map 62 may be displayed at arrival section 64, and may direct and/or otherwise facilitate travel of arriving avatars to the other sections and/or subsections of the teambuilding area. From arrival section 64, one or more of the other sections and/or subsections may be visible. For example, arrival section 64 may be elevated and may provide an overview of one or more of the other sections. As such, views of arrival section 64 may include distant views of one or more of the other sections, including other avatars performing the activities associated with the other sections and/or subsections. The arrival section 64 may include a mechanism that facilitates avatar travel to other sections within the teambuilding area. For example, the mechanism may include one or more of a map, a selectable listing of sections, virtual means of travel (e.g., boat, plane, train, magic carpet, mount, and/or other means of travel), and/or other mechanisms.

The communication section 66 may be configured to provide an environment in which activities performed in the teambuilding area can be discussed. The discussions may be held before activities are begun, during activities, and/or after activities are completed. Such discussions may include structured, formal discussions, unstructured, informal discussions, and/or other discussions. Aesthetically, communication section 66 may be represented in views of the teambuilding area as an environment in the real world in which conversations could be comfortably conducted. For example, communication section 66 may be represented in views of the teambuilding area as a lodge, sitting area, campfire, garden, and/or surrounding space.

The first subsection 76 of communication section 66 may include a lodge, and may be configured for participation in informal conversations by users. The first subsection 76 may include spaces where avatars can sit, lounge, walk, talk, and/or otherwise perform activities commonly associated with informal discussions in the real world. For example, first subsection 76 may be represented in views of the teambuilding area as a lodge. The lodge may include sitting areas, a fireplace, and/or other comfortable aesthetic features. The lodge may also provide virtual facilities for conducting group training and/or discussions related to the virtual space and teambuilding activities. For example, multimedia presentations may be available in the lodge with information about the teambuilding activities available in the teambuilding area or other topics, such as using various features and/or areas of the virtual space.

The second subsection 78 may be configured for more structured discussions of activities performed in the teambuilding area. By way of non-limiting example, second subsection 78 may be represented in views of the teambuilding area as a circle of objects on which avatars can be seated. The objects for seating avatars and/or other objects in second subsection 78 may be customizable by users and/or automatically based on individual preferences or strengths, performance in activities, to make points during discussion, and/or for other purposes.

Views of communication section 66 may include features of a real world environment conducive to communication. For example, communication section 66 may include one or more of a campfire, a garden, and/or other features conducive to group discussion or communication.

The first activity section 68, second activity section 70, third activity section 72, fourth activity section 74, and/or fifth activity section 75 may include content defining activities to be performed by the avatars under control of a group of users. For example, first activity section 68 may be configured for a group of avatars to travel through, having therein a plurality of crossroads at which a plurality of potential paths for proceeding through first activity section 68 may be presented to users controlling the group of avatars in views of first activity section 68.

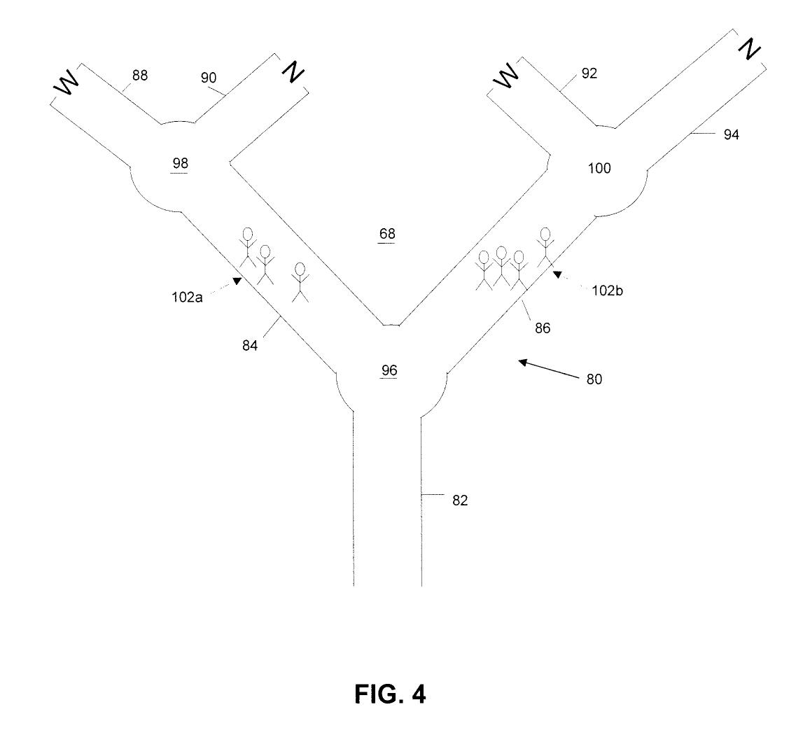

By way of illustration, FIG. 4 depicts a map 80 of first activity section 68. As can be seen in FIG. 4, first activity section 68 may include one or more of a first path 82, a second path 84, a third path 86, a fourth path 88, a fifth path 90, a sixth path 92, a seventh path 94, and/or other paths. The first path 82 may be connected to second path 84 and third path 86 at a first crossroads 96. The second path 84 may be connected with fourth path 88 and fifth path 90 at a second crossroads 98. The third path 80 may be connected with sixth path 92 and seventh path 94 at a third crossroads 100.

During an activity in the first activity section 68, a group of avatars 102 (illustrated in FIG. 4 as avatars 102a and 102b) may be introduced into first activity section 68 via first path 82. As avatars 102 proceed along first path 82, they may eventually arrive at first crossroads 96. At first crossroads 96 individual ones of avatars 102 may select to proceed via either second path 84 or third path 86. This may result in avatars 102 being divided into a first subgroup of avatars 102a and a second subgroup of avatars 102b, with avatars 102a proceeding along second path 84 and avatars 102b proceeding along third path 86. At each subsequent crossroad, avatars 102 may be further divided as individual ones of avatars 102 select different paths along which to proceed.

At a given crossroads, the choice of which path to take may be posed to the users controlling avatars 102 as a choice that may lead to a more effective attainment of some goal (e.g., getting through first activity section 68 the fastest, acquiring some virtual good within first activity section 68, and/or other goals). Information may be provided to users controlling avatars 102 while avatars 102 are at the given crossroads. This information may inform decisions of the users as to which path from the given crossroads their avatar will take. The information may be configured to distinguish different individual personality preferences, strengths, team roles, problem-solving styles, values, world views, and/or other distinctions between the ways in which users view the world and/or choices in their lives and in their group work.

Along paths 82, 84, 86, 88, 90, 92, and/or 94, users controlling avatars 102 may be presented with content providing information to help them make better choices. Such information may include clues as to how a goal within first activity section 68 can be attained, directions for proceeding within first activity section 68, and/or other information. As such, the path that one of avatars 102 takes through first activity section 68 may impact the information to which the user of the avatars 102 is exposed within first activity section 68.

After the avatars have proceeded through first activity section 68, and/or after some period of time within first activity section 68, the avatars 102 may be convened at a communication section of first activity section 68. Referring back to FIG. 3, the communication section may include second subsection 78 of communication section 66, a communication section specifically configured for discussions related to first activity section 68, and/or other communication sections of the teambuilding area.

Returning to FIG. 1, teambuilding module 32 may be configured such that the communication section to which avatars are directed subsequent to participation in the first activity section may include objects on which the avatars can sit, recline, lay, or otherwise dwell. The objects may include, for example, chairs, rocks, cushions, couches, and/or other objects. The objects may be customizable by the users controlling the avatars. Such customization may include alteration to include a name of an avatar or users, a group with which an avatar or user is affiliated, and/or other names. The customization may include the addition of still images and/or video. The still images and/or video may include still images and/or video captured and/or created in the virtual space, still images and/or video captured and/or created in the real world, and/or other still images and/or video. The objects may be customized to include, bear, or be associated with virtual goods. Such virtual goods may include tokens awarded to, found, obtained, earned, purchased, traded for, and/or otherwise acquired by the corresponding users. The objects may be reused for multiple communication sections within the teambuilding area, and/or may be for a single use. The objects may be represented in views of the communication section as being arranged in a configuration commonly used in the real world for communication sessions (e.g., in a circle, at a table, around a campfire, and/or other configurations).

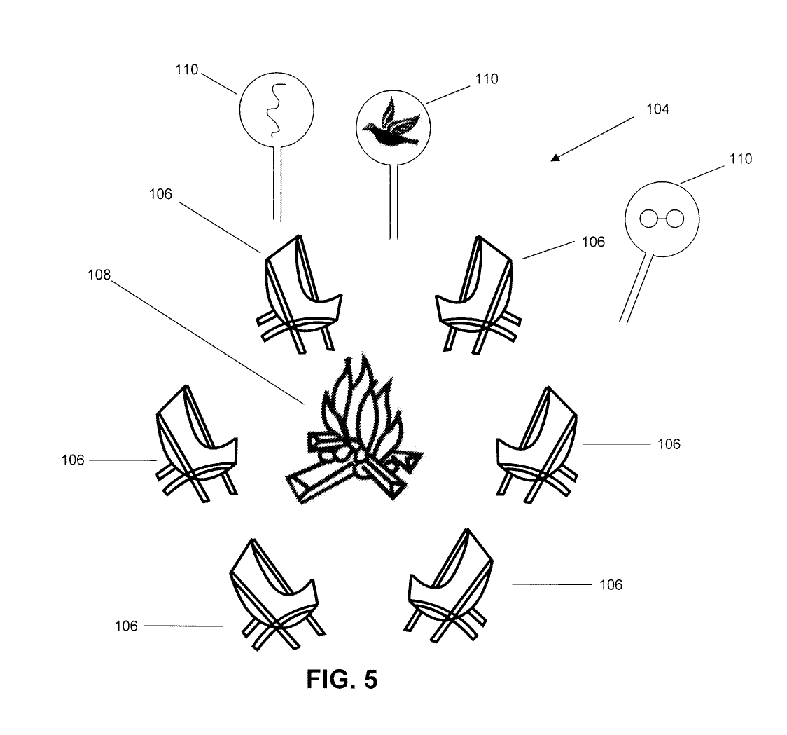

By way of example, FIG. 5 illustrates a view 104 of a communication section having therein objects 106 arranged around a campfire 108. Within the communication section, users that have completed the activity of the first activity section may be led in a discussion of the choices they made along the paths of their avatars through the first activity section. The discussion may include reasons that individual users made their choices at the crossroads, the different information and/or lessons learned along the paths, preferences that the choices indicate about the individual users and/or the group of users as a whole, and/or other aspects of the activity. During or after the communication section, users may obtain one or more virtual goods representing their choices within the first activity section. The virtual goods may represent choices and/or avatar paths of individual users and/or of the users as a group. For example, view 104 includes a set of virtual goods 110 represented as sign posts displaying different animals that represent preferences and strengths. Users may select and/or be assigned one or more animal representations (or other symbolic representations) of strengths and/or preferences. For example, a phoenix may symbolize a personality type of a user that finds a solution to emerge from a difficult situation. A turtle may symbolize the personality type of a user who is methodical and deliberate at work. Other examples of symbols for individual preferences and strengths are contemplated. The users may be provided with one or more virtual goods including the representation(s) they have been assigned or have selected. The virtual goods may be carried by the avatars being controlled by the users, may be reflected in the attire of the avatars, be included in objects 106 of the users, and/or otherwise received by the users.

Referring back to FIG. 1, the activity presented to users by the first section of the teambuilding area provided by teambuilding module 32 may improve group unity, the ability to work together to better find solutions by creating awareness, understanding, and/or respect for individual and team preferences. The teambuilding module 32 may be configured such that the paths, the crossroads, the goals, the information along the paths, and/or other aspects of the first activity section may be customized to a specific entity and/or group of users associated with an entity. As such, the configuration of the first activity may be somewhat modular, thereby facilitating meaningful teambuilding interactions customized to a particular audience. The teambuilding module 32 may be configured such that an activity in the first section of the teambuilding area may be repeated by a group. Such repetition may improve understanding and/or respect for individual and/or group preferences, differences, and/or strengths.

The teambuilding module 32 may be configured such that standard tools and techniques used by entities to help individuals understand and apply their preferences and strengths to group work may be integrated into the first section of the teambuilding area. For example, one or more of Myers-Briggs personality-type indicators, Enneagrams, Belbin team roles, and/or other tools or techniques that may improve self and/or group awareness and leveraging of preferences and strengths may be integrated into the first activity area of the teambuilding section (and/or into the corresponding communication section).

Returning to FIG. 3, second activity section 70 may be configured such that a group of avatars are subjected to a common set of content. This set of content may define a common and shared experiential environment for the group. The common experiential environment may include a path or journey along which the group of avatars may travel and/or be transported. For example, this may be represented in views of second activity section 70 as the avatars being conveyed along a waterway by way of watercraft (e.g., river raft, canoe, and/or other watercraft). At various points in the common experiential environment defined by the set of content (e.g., along the path or waterway), questions may be presented to users controlling the avatars. The users may be encouraged and/or required to answer the questions. Answers to the questions may be received via client platform, and/or kept locally by the users. Answers to the questions may be received by way of public texting, voice communications, and/or other mechanisms for communication input by the users at client platforms.

The questions may be designed to facilitate identification of motivational drivers for engagement with the entity associated with the virtual space, for engagement with a project for the entity, for engagement with a group associated with the entity, and/or for other activities or roles. As such, as the avatars proceed within second activity section 70 in answering questions, individual users and/or the group may recognize their motivation for engaging in an activity or role associated with the entity, create a motivating vision of the future of an activity or role associated with the entity, define criteria for individual and/or group success, inspire individuals and/or groups to strive to achieve success, and/or receive other personal and group benefits. This activity may be repeated to refine, change, or reinforce individual or group motivations and/or visions of success.

A teambuilding module (e.g., teambuilding module 32 in FIG. 1) providing second activity section 70 may be configured such that the questions are modular, and separate from the set of content. As such, second activity section 70 may be customized for an entity, a specific group of users, a specific user, and/or other groups or users by simply replacing or adjusting the questions and leaving unchanged the common experiential environment defined by the set of content through which avatars proceed.

Subsequent to the avatars proceeding through the journey defined by the set of content in second activity section 70, the avatars may be convened at a communication section of the teambuilding area. The communication section may include, for example, second subsection 78 of communication section 66, a communication section designed specifically for second activity section 70 and/or other communication sections. In the communication section, the users controlling the avatars that proceeded through second activity section 70 may be encouraged to discuss their answers to the questions. The discussion may include the development of an individual and/or shared group vision, a group goal or objective, and/or other group-based or individual concepts.

The teambuilding module providing the teambuilding area (e.g., teambuilding module 32 in FIG. 1) may be configured such that third activity section 72 comprises a task or goal to be achieved by a group of avatars. The task or goal may include overcoming one or more obstacles. By way of non-limiting example, within third activity section 72, the group of avatars may be challenged to traverse, within the virtual space, a rushing river to find a rare article of flora or fauna (e.g., a bristled pinecone), to traverse, within the virtual space, a rickety or unstable bridge to find a rare article of flora or fauna (e.g., a specific bird feather), to hike up, within the virtual space, an icy mountain to locate a rare mineral (e.g., a valuable gem), and/or other tasks with defined goals and/or objectives.

The teambuilding module may be configured such that prior to beginning the task with defined objectives, the users controlling the group of avatars obtain a set of values. The set of values may include one or more values selected by the users, one or more values assigned to the users, and/or one or more values obtained in other ways. Some non-limiting examples of values may include one or more of teamwork, trust, collaboration, winning, efficiency, customer service, and/or other values. The users may be required to adhere to the obtained set of values during performance of the task or objective. When faced with obstacles or challenges, the users may be required to make decisions in alignment with the values in the obtained set of valdes while controlling their avatars. The individual and/or group decisions about how to achieve their objective may be impacted based on the values that they are provided with. By varying the set of values obtained by a group of users, the objectives dr tasks provided in second activity section 70 may be repeated numerous times without yielding the same experience. Each time the group of users participate in second activity section 70, they may gain an understanding of the challenges and difficulties of a group making value-based decisions when faced with obstacles and pressures to succeed.

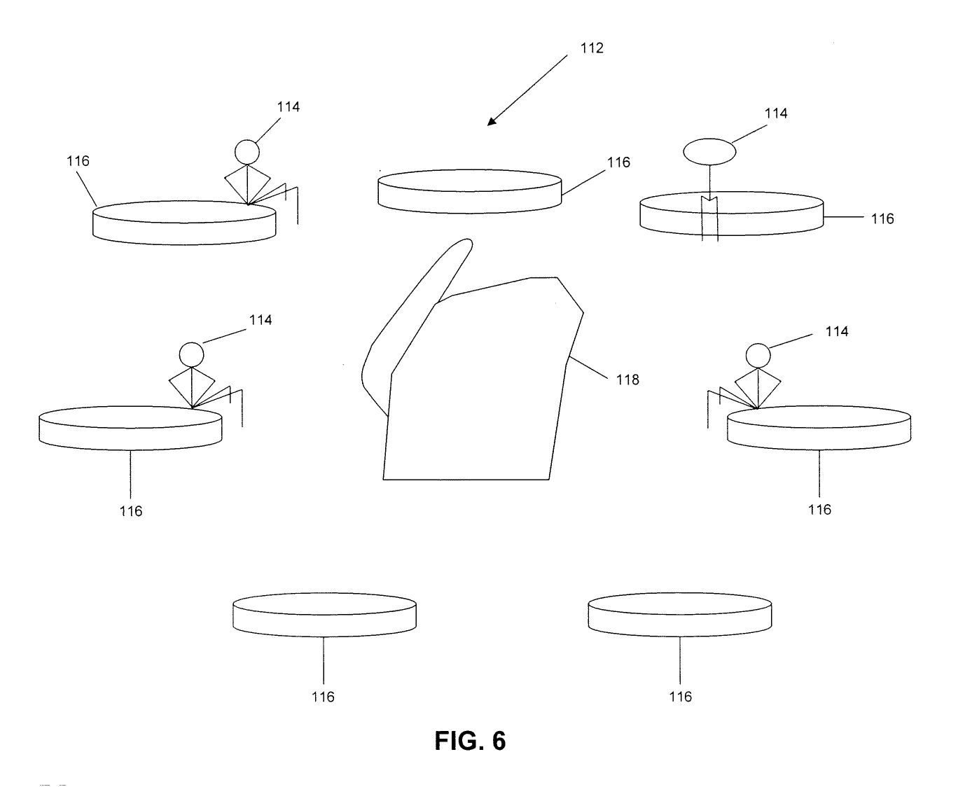

The teambuilding module providing the teambuilding area (e.g., teambuilding module 32 of FIG. 1) may be configured such that before, after, or as the group completes an objective or task in third activity section 72, the group of avatars is convened in fourth activity section 74. FIG. 6 may illustrate a view 112 of fourth activity section 74 presented to users controlling the group of avatars. The view 112 may include a set of objects 116 that correspond to individual avatars 114 in the group. The objects 116 may be configured such that the avatars 114 can sit, stand, recline, or otherwise dwell on or in them, or objects 116 may be provided separately from objects on which the avatars 114 can sit, stand, recline or otherwise dwell. The view 112 may include a group object 118.

In fourth activity section 74, users controlling avatars 114 may be presented with a set of values. The values presented may include values assigned to the group during participation in the task or object of the second activity section, and/or other values (e.g., values selected by the entity). Selections by the users of individual values from the set of values may be elicited and/or received. Responsive to such selection, objects 116 may be customized to reflect the values selected by the users corresponding to the individual objects 116. Since the selection takes place following participation in completing the objective or task of the second activity section, the users may be particularly attuned to the meaning and/or challenges of making value-based decisions. The recent experience of the second activity section may inform decisions of the users in selecting values from the set of values.

In fourth activity section 74, the users controlling the avatars 114 may be encouraged to discuss their individual selection of values. The reflections of the selected values in objects 116 may serve to direct the conversation and/or hold the attention of users to listen to and to learn from other users about their own selections. This appreciation for differences in individual users' values may enhance team unity and/or the ability to work together to create innovative solutions. In some implementations, one or more virtual goods associated with selections of values made in fourth activity section 74 may be provided to the users for use elsewhere in the virtual space (e.g., to customize an object within second subsection 78 of communication section 66).

In fourth activity section 74, the users may collectively select values for the group. As the users select and/or deselect values for inclusion in their collective set of values, group object 118 may be dynamically adjusted to reflect the choices. For example, group object 118 may include a statue that is adjusted based on the selection of values for the group. Upon selection of a set of group values, virtual goods reflecting the final status of group object 118 may be distributed to individual users in the group. Virtual goods reflecting the final status of the group object may be displayed in views of other areas and/or sections of the virtual space as a reminder of group values.

The selection and discussion of individual and group values may facilitate understanding and/or respect between the users. Such understanding may include appreciation of how age, gender, culture, and/or life experience may impact individual values and/or decision-making. The understanding facilitated and/or fostered within fourth activity section 74 may enhance value-based decision-making by the group as they work together on projects and/or find solutions to problems.

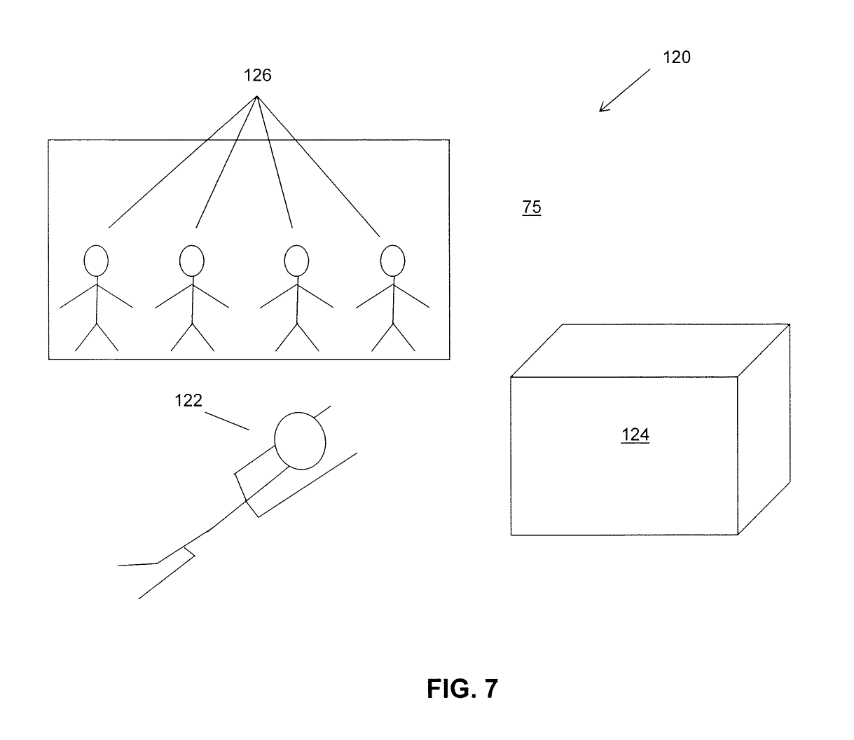

Referring back to FIG. 3, the teambuilding module providing the teambuilding area (e.g., teambuilding module 32 of FIG. 1) may be configured such that fifth activity section 75 in which a task is to be performed by an individual avatar from a group of avatars, or by a subset of the avatars in the group of avatars. In views of fifth activity section 75 presented to users controlling the avatars performing the task, the other avatars in the group may be visible. By way of illustration, FIG. 7 shows a view 120 of fifth activity section 75 presented to a user controlling an avatar 122 to perform a task 124. In view 120, avatars 126 in an avatar group with avatar 122 that are not performing task 124 may also be visible. The environment and conditions surrounding task 124 may be designed to create stress in the user(s) performing task 124. For example, task 124 may be timed or limited by other external conditions to increase difficulty in performing the task. For example, view 120 may represent task 124 as being performed underwater so that avatar 122 must perform task 124 before running out of air.

The teambuilding module may be configured such that users controlling avatars 126 may be assigned responses to the performance of the task by avatar 122. The responses may be the same or different for the individual avatars 126. The responses may include types of responses. The responses may include, for example, supportive or encouraging, unsupportive or discouraging, non-expressive, and/or other responses. The users controlling avatars 126 may be instructed to control avatars 126 to express the assigned responses. Expression and/or conveyance of the assigned responses may be performed via direct communication (e.g., textual, vocal, and/or other direct communication), indirect communication (e.g., avatar body language, and/or other indirect communication), and/or other communication. The avatars 126 may be controlled automatically by the teambuilding module to express the assigned responses. Since avatars 126 may be present in views of fifth activity section 75 presented to the user controlling avatar 122, perceived responses of group members during performance of task 124 may impact the user controlling avatar 122 during performance of task 124. The teambuilding module may be configured such that the user controlling avatar 122 proceeds through a set of tasks including task 124. Successive tasks may increase in difficulty.

Referring back to FIG. 3, subsequent to completion of fifth activity section 75, the group of avatars may be convened in a communication section. The communication section may include second subsection 78 of communication section 66, and/or other communication sections. In the communication section, the users controlling the group of avatars may be lead in a discussion of the impact of the observing avatars on the ability of the user(s) controlling the avatar(s) to perform the task(s) of fifth activity section 75. Tools and/or techniques may be presented to the group that may alleviate stress. Such tools and/or techniques may include one or more of biofeedback tools and/or technology, breathing techniques, visualization, meditation, and/or other tools and/or techhiques to help individual and/or groups monitor and enhance coherence. Tools and/or techniques may be modified based on the preferences, tools, and/or requirements of the entity.

The group training and discussion may facilitate understanding by the users of the impact of group support on stress and job performance. This understanding may and use of tools and/or techniques to alleviate stress may enhance performance by the group in working on problems and/or tasks in the future.

The teambuilding module providing the team building area may be configured such that fifth activity section 75 may be designed to provide a plurality of tasks and/or difficulty levels. By varying the task, the difficulty level, and/or the responses or reactions assigned to the non-performing avatars, the activities of fifth activity section 75 may be repeated multiple times while still providing new experiences that build group unity, support, and/or coherence throughout the group's work. The teambuilding module may be configured such that other teambuilding experiences, activities, and/or tools may be added to the teambuilding area based on entity preferences, tools, and/or requirements.

Returning to FIG. 1, idea generation module 34 may be configured such that the virtual space comprises an idea generation area including content designed to facilitate cooperative generation, capture, selection, prioritization, tracking, and/or inventory of ideas by individuals and/or groups of users. This content may include creativity tools and/or activities. The idea generation area may be designed to facilitate generation of ideas for solutions that benefit the entity. For example, the idea generation area may be designed to facilitate generation of ideas for solutions to improve client service, organizational development, product development, and/or other internal or external solutions related to the entity. The idea generation module 34 may be configured such that the idea generation area may be restricted to be viewable only to users associated with the entity and/or to third party uses external to the entity. In some implementations, idea generation module 34 may be configured such that the idea generation area, a section of the idea generation area, and/or an instance of the idea generation area may be restricted to a predetermined set of users. The predetermined set of users may include users associated with the entity and/or users external to the entity. In such implementations, idea generation module 34 may cooperate with security module 26 to ensure that unauthorized users are not provided with views, sounds, and/or other media associated with the restricted area, section and/or instance.

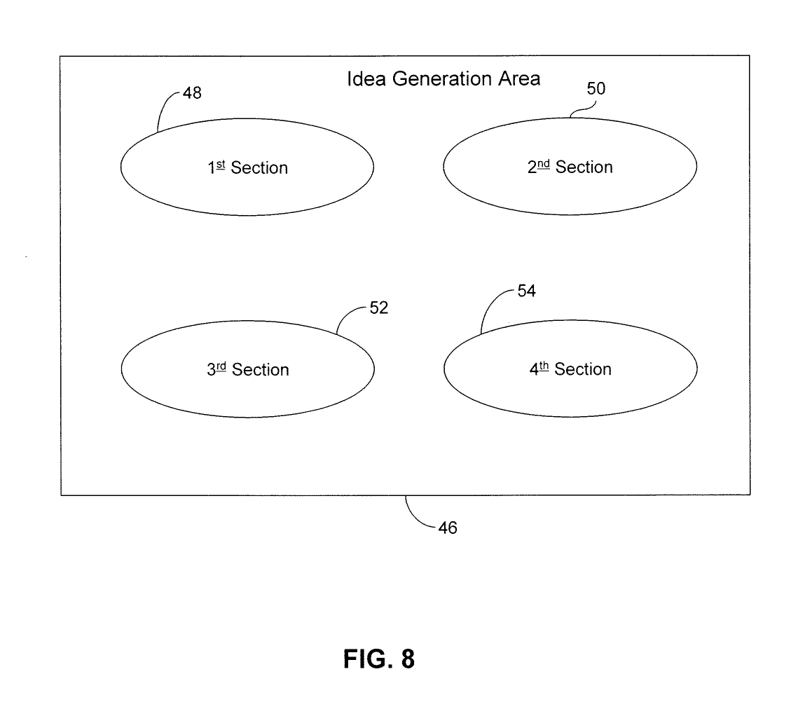

The idea generation module 34 may be configured such that the idea generation area comprises a plurality of separate sections configured with tools and/or activities to facilitate different types of creative thinking in order to generate innovative ideas. By way of illustration, FIG. 8 depicts a map 46 of the idea generation area. In some implementations, the idea generation area may include one or more of a first section 48, a second section 50, a third section 52, a fourth section 54, and/or other sections. The map 46 may be presented to users upon entry of avatars controlled by the users to the idea generation area. The map 46 may be present in the various sections 48, 50, 52, and/or 54. The map 46 may be configured to facilitate travel between the various sections 48, 50, 52, and/or 54. The map 46 may include other areas of the virtual space and/or may facilitate travel to other the other areas from within the idea generation area.

Returning to FIG. 1, the idea generation module 34 may be configured such that a first section of the idea generation area includes content configured to facilitate brainstorming by individuals and/or a group of users. The content may include scenery, tools, characters, documents, photos, objects, and/or other content. For example, first section 48 may include brainstorming tools to display visual representations of ideas generated by users. The visual representations may be visible in views of the first section as one or more surfaces that display text and/or markings generated by one or more users. The idea generation module 34 may be configured to receive such text and/or markings via client platforms 18. The one or more surfaces may be represented in views of the first section as real world surfaces that traditionally display text and/or markings as part of a brainstorming process. For example, the one or more surfaces may be represented as one or more of a sticky note (e.g., having a user selectable color), a white board, a chalk board, note paper, and/or other surfaces. One or more aspects of the text or markings generated by users may be selectable by users. For example, the font, color, highlighting, size, spacing, and/or other aspects of the text or markings may be selectable by users. In the first section, the one or more surfaces may be clearly visible in views of the first section so as to share the text and/or markings with all (or substantially all) users viewing views of the first section.

The first section 48 may be integrated with one or more applications designed to facilitate idea generation, capture, selection prioritization, tracking, and/or inventory. Such tools may include, for example, the tools provided by Brightldea®, the tools provided by Mindmap®, and/or other tools. Ideas generated within first section 48 may be captured by saving text or markings generated by users, recording voice communications, storing files created with tools integrated with the first section, and/or storing files capturing ideas conceived or expressed within the first section.

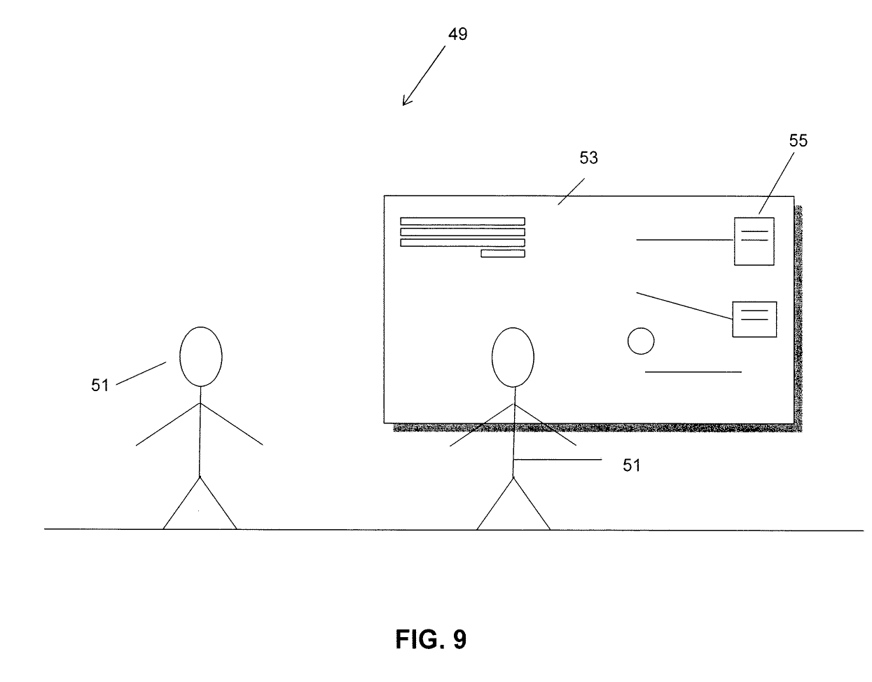

FIG. 9 illustrates a view 49 of the first section 48 of the idea generation area, according to some implementations. The view 49 may include an avatar 51 being controlled by a user, a first surface 53, and a second surface 55. The first surface 53 and second surface 55 may display text created by users. The second surface 55 may be represented as a sticky note. The first surface 53 may be represented as a white board.

Returning to FIG. 1, the idea generation module 34 may be configured such that a second section of the idea generation area, separate from the first section of the idea generation area, has different content designed to facilitate cooperative generation of ideas by individuals and/or groups of users through role-playing and/or simulation. The content may include scenery, tools, activities, characters, documents, photos, objects, and/or other content. Such content may define a virtual venue configured for simulations of real world interactions by avatars. The simulations may be performed by avatars under the control of users via client platforms 18. The venue may be viewable (and heard), along with avatars performing simulations therein, in views of the second section.

The venue may comprise a portion of the second section that is visibly prominent in views of the second section. The visible prominent portion of the second section may be configured for the performance of simulations therein. The venue may be represented in views of the second section having features of real world venues for performance of sales and/or customer interactions, employee interactions, awards ceremonies, demonstrations, shows, and/or other simulations. For example, the prominent portion of the second section may be represented in views of the second section as a stage.

In some implementations, the venue in the second section may be represented in views of the second section as a simulated environment similar to a real world environment in which people would interact on matters related to the entity. For example, the second section may be represented as an office, a retail environment, a worksite, and/or other environments simulating the real world. The second section be integrated or usable with one or more tools or applications designed to facilitate idea generation, capture, selection, prioritization, tracking, and/or inventory during or after simulations or role plays. Simulations or role plays may be recorded and stored. Stored simulations may be used for demonstration within the virtual space and/or outside of the virtual space.

The idea generation module 34 may be further configured such that the venue includes seating for avatars controlled by users observing a simulation or role play. Such seating may include one or more objects upon which avatars under the control of users can sit. The objects may be arranged in the second section such that the prominent portion of the second section is present in views of the second section having points of view that correspond to the objects (e.g., the prominent portion may be viewable by avatars sitting on the objects). The objects may be represented in views of the second section as chairs, benches, and/or other objects.

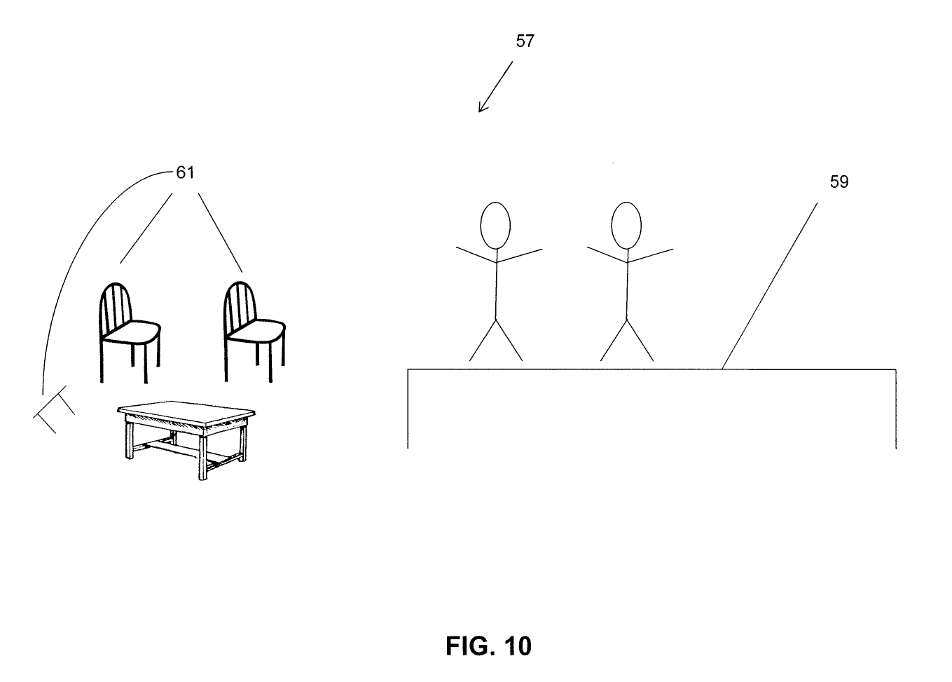

FIG. 10 illustrates a view 57 of the second section of the idea generation area, according to some implementations. The view 57 may include a prominent portion 59 of the second section, avatars 61 performing a simulation or role play in the prominent portion 59, objects 61 on which avatars can assemble around the simulation or role play, and/or other features. In FIG. 10, prominent portion 59 may be represented as a stage and objects 61 may be represented as seats in view 57.

Returning to FIG. 1, the idea generation module 34 may be configured such that a third section of the idea generation area, separate from the first section and the second section, has different content designed to facilitate cooperative generation of ideas by users. The content may include scenery, tools, activities, characters, documents, photos, objectives, and/or other content. The third section may be designed to facilitate visualization of prototypes and/or their operation. As such, idea generation module 34 may be configured to provide users with controls for creating virtual design prototypes. The virtual design prototypes may include three-dimensional prototypes of products, buildings, operational devices, and/or other objects. The controls may be provided to the users via a user interface presented to the users on client platforms 18. The controls may be configured to receive input from the users related to the size, orientation, shape, color, mobility, and/or other aspects of components of the virtual prototypes. The controls may be configured to receive selections of pre-existing objects, modifications to pre-existing objects, creation of new objects, and/or other selections facilitating creation of virtual prototypes. Pre-existing objects may include objects created within the virtual space and/or objects created using other applications (e.g., CAD/CAM objects, and/or other objects). The third section may be integrated or usable with one or more tools or applications designed to facilitate idea generation, capture, selection, prioritization, tracking, and/or inventory before, during, and/or after prototype modeling.

The idea generation module 34 may be configured such that a fourth section of the idea generation area, separate from the first section, the second section and the third section, has different content designed to facilitate cooperative generation of ideas by individuals and/or groups of users. The fourth section of the idea generation area may be configured to facilitate three dimensional data visualization. As such, idea generation module 34 may be configured to receive multi-dimensional data (e.g., from a spreadsheet file, and/or from other files), and to generate a three-dimensional representation of the data. The three-dimensional data may be stored in electronic storage 20 and/or received from one of external resources 16. The idea generation module 34 may be configured to receive selection and/or input by users of adjustments, additions, deletions, and/or other alterations of the data. Alteration of the data by users may result in adjustment of the three-dimensional representation of the data. The fourth section may be integrated or usable with one or more tools or applications designed to facilitate idea generation, capture, selection, prioritization, tracking, and/or inventory before, during, and/or after data visualization.

By providing the first, second, third, fourth, and/or other sections separately, idea generation module 34 may spatially separate different creative activities associated with finding solutions benefitting the entity. This spatial separation may enhance creativity, organize group and/or individual creativity and/or thought, and/or provide other enhancements. The idea generation module 34 may be configured such that other group idea generation experiences, activities, and/or tools may be added to the idea generation area based on entity preferences, tools, and/or requirements.

The collaboration module 36 may be configured such that the virtual space includes a collaboration area including content designed to facilitate interaction between internal users associated with the entity, external third party users, and/or other visitors. Third party users or visitors may refer to users that do not have access to one or more other areas of the virtual space (e.g., the idea generation area, the teambuilding area, etc.). Such users may not have access to the one or more other areas because they are not directly associated with the entity corresponding to the virtual space. For example, such users may be business partners of the entity (and/or of users associated with the entity), guests of the entity (and/or of users associated with the entity), clients or potential clients of the entity (and/or of users associated with the entity), and/or other third party users or visitors.

The collaboration module 36 may be configured such that the collaboration area comprises one or more public sections and/or one or more private sections. The collaboration area may be arranged such that interactions between users controlling avatars (or otherwise being present) in a public section may be observable by and heard by other users in views of the public section. The collaboration area may be arranged such that interactions between users controlling avatars (or otherwise being present) in a private section may only be observable to and heard by a predefined group of users. The predefined group of users may be the group of users controlling avatars (or otherwise being present) in the private section.

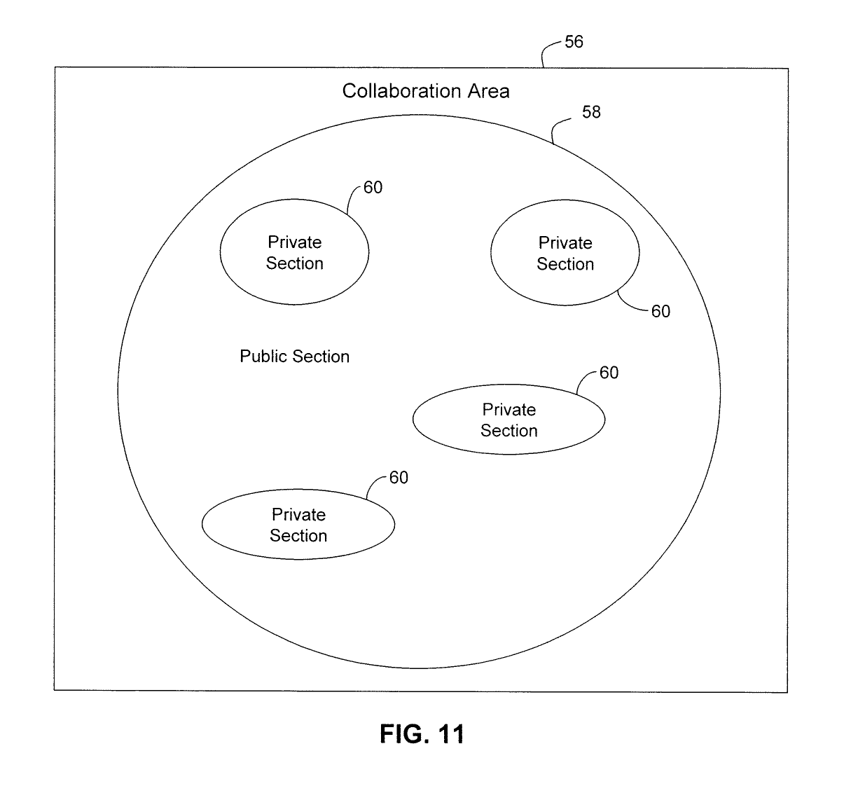

By way of illustration, FIG. 11 depicts a map 56 of a collaboration area made up of a public section 58 and a plurality of private sections 60. One of private sections 60 may function as a virtual private room in which content is displayed, noises generated, and/or other exchanges of information and/or ideas are contained to views presented to users controlling avatars within the private section 60. Entry of avatars to one of private sections 60 may be controlled by a user or set of users. Public section 58, on the other hand may be open to all users that obtain entry to the collaboration area. Although the public section 58 may include objects that obstruct views of public section 58, by maneuvering an avatar and/or a point of view within public section 58 a user may be able to gain access to interactions or activities transpiring within public section 58. The presence of private sections 60 within the collaboration area may provide a mechanism within the virtual space for including business partners, clients or potential clients, friends, and/or other users not associated with the entity in private use of the three-dimensional immersive environment of the virtual space. Aesthetically, public section 58 and/or private sections 60 may be represented in views of the collaboration area as conference rooms, pods, booths, lofts, and/or other areas. These areas may include content such as scenery, tables, chairs, lighting, multi-media displays, branding and logos, and/or other objects associated with public and/or private collaboration areas.

Referring back to FIG. 1, the collaboration module 36 may be configured such that the public or private sections include tools for presenting ideas, proposals, and/or other content generated by users. Such tools may be implemented to create such content in real-time and/or to present content that has been previously created (e.g., word processing files, spreadsheet files, presentation files, websites, video files, application data, and/or other content). The collaboration module 36 may be configured such that other collaboration experiences, activities, and/or tools may be added to the collaboration area based on entity preferences, tools, and/or requirements

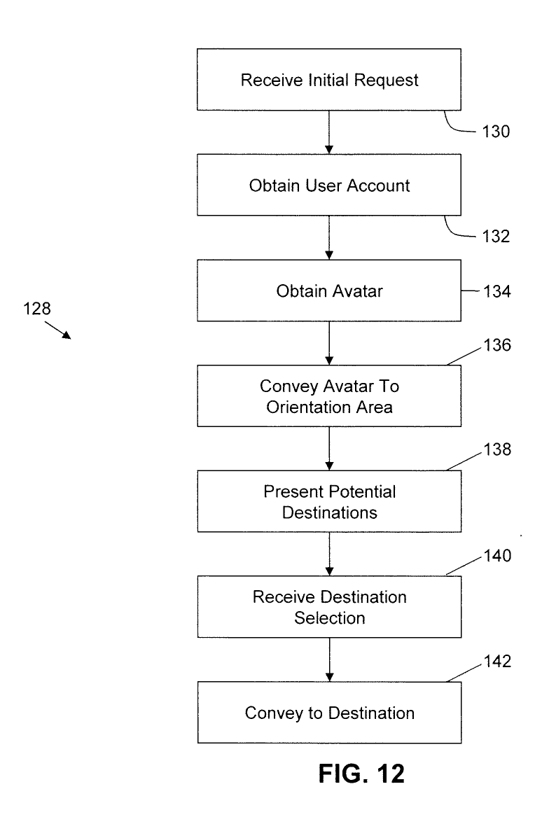

FIG. 12 illustrates a method 128 of providing a virtual space to users associated with a real world entity. The virtual space may be configured to enhance innovation within the real world entity. The enhancement of innovation of the real world entity may be accomplished through enhanced cooperation and/or teamwork between users, enhanced group-based idea generation, and/or enhanced collaboration with third parties and the real world entity. The operations of method 128 presented below are intended to be illustrative. In some embodiments, method 128 may be accomplished with one or more additional operations not described, and/or without one or more of the operations discussed. Additionally, the order in which the operations of method 128 are illustrated in FIG. 12 and described below is not intended to be limiting.

In some embodiments, method 128 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 128 in response to instructions stored electronically on an electronic storage medium. The one or more processing devices may include one or more devices configured through hardware, firmware, and/or software to be specifically designed for execution of one or more of the operations of method 128.

At an operation 130, an initial request for access to an instance of the virtual space may be received. The initial requested may be received from a user that has not previously accessed the virtual space. The initial request may be received via a client platform being used by the user. The initial request may be generated in response to an invitation that was previously sent to the user. The initial request may include security information indicating that the user should be provided with access to the virtual space. Such security information may include one or more of security information that is associated with the entity generally, information that is associated with a specific potential user, information that is usable for a single initial request (e.g., temporary security information), and/or other security information. In some implementations, operation 130 may be performed by a security module that is similar to or the same as security module 26 (shown in FIG. 1 and described above).

At an operation 132, responsive to the security information in the initial request being valid, an account for the user may be created. The account may include identification information, inventory information, security information, entity role information, demographic information, usage information, and/or other information associated with the user. If the virtual space is a secure portion of a larger virtual world, the generation of a separate account may be foregone. The information included in the account may include information stated by the user and/or information obtained through automated processes (e.g., monitoring and/or querying previously stored information). In some implementations, operation 132 may be performed by an account module that is similar to or the same as account module 28 (shown in FIG. 1 and described above).

At an operation 134, an avatar for the user may be obtained. The avatar may be generated automatically for the user, may be obtained from a previously generated set of avatars, may have been previously generated for another virtual space, may be generated based on input received from the user, and/or otherwise obtained. In implementations in which the virtual space is a secure portion of a larger virtual world, obtaining an avatar for the secure portion of the larger virtual world may be foregone. In some implementations, operation 136 may be performed by an orientation module that is similar to or the same as orientation module 30 (shown in FIG. 1 and described above).

At an operation 136, the avatar may arrive at an orientation area. Views of the orientation area may be provided to the user via the client platform. The orientation area may include content instructing the user on use of the virtual space. In some implementations, the orientation area may be provided by an orientation module similar to or the same as orientation module 30 (shown in FIG. 1 and described above).

At an operation 138, destinations within the virtual space may be presented to the user in views of the virtual space. The destinations may include separate areas formed within the virtual space. The separate areas may include one or more of an idea generation area, an collaboration area, a teambuilding area, and/or other areas. The idea generation area may have content therein designed to facilitate cooperative generation of ideas by users for solutions (e.g., solutions related to the entity). The idea generation area may be restricted to users associated with the entity. The idea generation area may be provided by an idea generation module similar to or the same as idea generation module 34 (shown in FIG. 1 and described above). The collaboration area may have content therein facilitating interaction between users associated with the entity and users from outside the entity (e.g., visitors). Third party users with which users associated with the entity interact in the collaboration area may include business partners, clients, potential clients, allies, and/or other third parties to the entity. The collaboration area may be provided by a collaboration module similar to or the same as collaboration module 36 (shown in FIG. 1 and described above). The teambuilding area may have content therein designed to facilitate teambuilding between users associated with the entity. The teambuilding area may be provided by a teambuilding module similar to or the same as teambuilding module 32 (shown in FIG. 1 and described above).

At an operation 140, input may be received from the user indicating which of the areas the avatar obtained at operation 134 should be conveyed to. The input may be received from the user via the client platform. At an operation 142, responsive to reception of the input at operation 140, the avatar may be conveyed to the indicated area of the virtual space. Conveyance of the avatar to the indicated area may result in presentation of views on the client platform of the indicated area. The views may be generated from a point of view corresponding to the position of the avatar. In some implementations, operations 140 and/or 142 may be performed by a server that is similar to or the same as servers 12 (shown in FIG. 1 and described above).

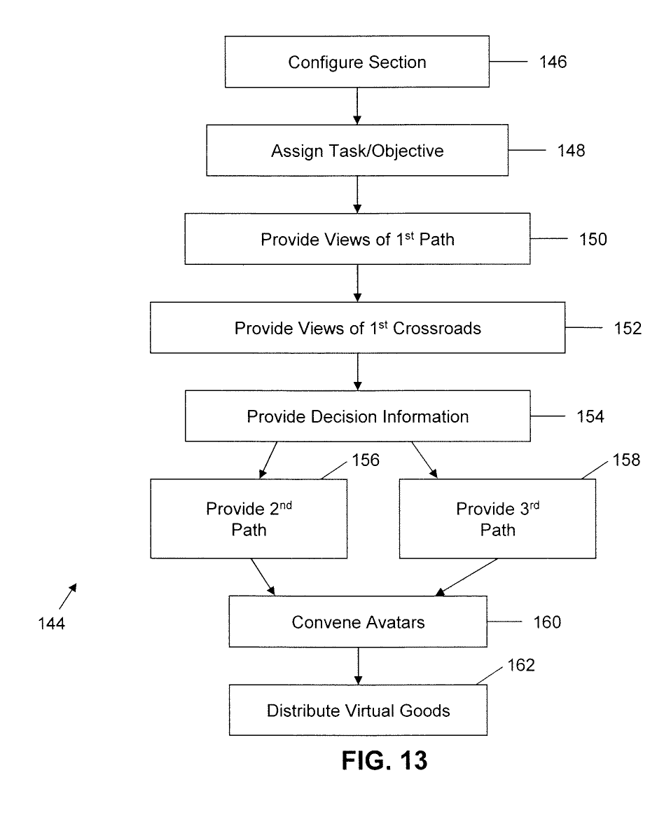

FIG. 13 illustrates a method 144 of providing a teambuilding activity in a virtual space to users associated with a real world entity. The virtual space may be configured to enhance innovation of the real world entity. The operations of method 144 presented below are intended to be illustrative. In some embodiments, method 144 may be accomplished with one or more additional operations not described, and/or without one or more of the operations discussed. Additionally, the order in which the operations of method 144 are illustrated in FIG. 13 and described below is not intended to be limiting.

In some embodiments, method 144 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 144 in response to instructions stored electronically on an electronic storage medium. The one or more processing devices may include one or more devices configured through hardware, firmware, and/or software to be specifically designed for execution of one or more of the operations of method 144. By way of example, one or more of the operations of 144 may be performed by a teambuilding module similar to or the same as teambuilding module 32 (shown in FIG. 1 and described above).

At an operation 146, a section of a teambuilding area may be configured to present a teambuilding activity to users controlling a group of avatars. In some implementations, operation 146 may include configuring a section of a teambuilding area similar to or the same as section 68 (shown in FIGS. 3 and 4 and described above).

At an operation 148, a task, problem, or objective may be assigned to the users controlling the group of avatars. Information for facilitating in performance of the task or object and/or solving the problem may be included within the section configured at operation 146. The task, problem, or objective may be conveyed to the users in views of the virtual space, and/or otherwise communicated.

At an operation 150, the group of avatars may be disposed in a first path of the section of the teambuilding area. This may result in views of the virtual space being generated that represent the first path of the section of the teambuilding area being presented to the users controlling the avatars. The first path may be similar to or the same as first path 82 (shown in FIG. 4 and described above).

As the avatars progress along the first path, the avatars may arrive at a first crossroads at an operation 152. The first crossroads may provide access for the avatars to a second path and a third path. Arrival at the first crossroads may result in the first crossroads being present in views of the virtual space presented to users controlling the avatars. In some implementations, the first crossroads, the second path, and the third path may be similar to or the same as first crossroads 96, second path 84, and/or third path 86, respectively (shown in FIG. 4 and described above).

At an operation 154, information related to the decision of whether to control the avatars to proceed along the second path or the third path may be provided to the users. The information may be configured to distinguish different problem-solving styles, different values, different world views, and/or other distinctions between the ways in which users view the world and/or choices in their lives. Responsive to a first subset of the avatars being controlled to proceed along the second path, views of the virtual space representing the second path may be provided to the users controlling the first subset of avatars at an operation 156. Responsive to a second subset of avatars being controlled to proceed along the third path, views of the virtual space representing the third path may be provided to the users controlling the second subset of avatars at an operation 158. Along the first, second, third, and/or other paths within the section of the teambuilding area, views of the virtual space presented to users may include information specific to the particular path on which an avatar is located. Such information may include clues as to how a goal, objective, or task within the section can be attained, directions for proceeding within the section, and/or other information. As such, the path that one of the avatars takes through the section may impact the information to which the user of the avatars is exposed within the section. The section may present users controlling the subgroups of avatars with additional crossroads and potential paths through the section.

At an operation 160, the avatars may be convened at a communication section of the teambuilding area. At the communication section, the users controlling the avatars may be lead in a discussion of the choices made within the activity section, what these say about individual users and/or the team as a whole, the success or failure of the group and/or individual users in attaining the assigned task or objective, and/or other aspects of the teambuilding activity. The communication section may be similar to or the same as second subsection 78 of communication section 66 (shown in FIG. 3 and described above), and/or the communication section represented in FIG. 5.

At an operation 162, one or more virtual goods may be obtained by users controlling the avatars. The one or more virtual goods may represent the choices of paths made by the individual users and/or the group of users in the activity section. The one or more virtual goods may be usable within the virtual space.

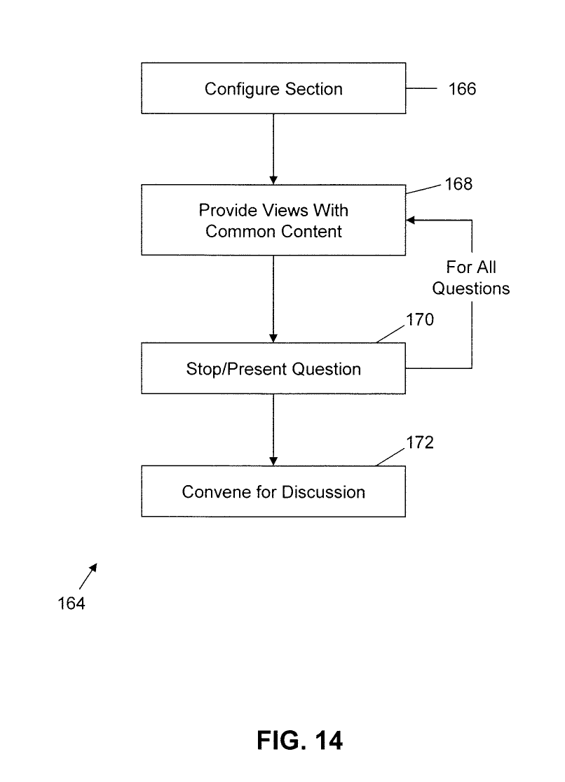

FIG. 14 illustrates a method 164 of providing a teambuilding activity in a virtual space to users associated with a real world entity. The virtual space may be configured to enhance innovation by the real world entity. The operations of method 164 presented below are intended to be illustrative. In some embodiments, method 164 may be accomplished with one or more additional operations not described, and/or without one or more of the operations discussed. Additionally, the order in which the operations of method 164 are illustrated in FIG. 14 and described below is not intended to be limiting.

In some embodiments, method 164 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 164 in response to instructions stored electronically on an electronic storage medium. The one or more processing devices may include one or more devices configured through hardware, firmware; and/or software to be specifically designed for execution of one or more of the operations of method 164. By way of example, one or more of the operations of 164 may be performed by a teambuilding module similar to or the same as teambuilding module 32 (shown in FIG. 1 and described above).

At an operation 166, a section of a teambuilding area may be configured to present a teambuilding activity to users controlling a group of avatars. Configuration of the activity section of the teambuilding area may include a common set of content to be experienced by the users controlling the group of avatars together. In some implementations, operation 166 may include configuring a section of a teambuilding area similar to or the same as section 70 (shown in FIG. 3 and described above).

At an operation 168, views of the virtual space representing the common content may be provided to the users controlling the avatars. The views may represent, for example, the avatars progressing along a route, waterway, or path together.

At an operation 170, one question in a series of questions may be posed to the individual users controlling the avatars. In some implementations, the series of questions may be obtained at operation 166 as part of the configuring the activity section of the teambuilding area. At operation 170, answers from the individual users to the presented question may be obtained. Operations 168 and 170 may be looped until the series of questions has been posed and/or the common content has been exhausted. The questions may be designed to facilitate identification by individual users of motivations for involvement with the entity associated with the virtual space, for involvement with a project for the entity, for involvement with a group associated with the entity, and/or for other activities or roles. As such, as operations 168 and 170 are looped, individual users may begin to receive motivation for an activity or role associated with the entity, understand a purpose of an activity or role associated with the entity, and/or receive other benefits.

At an operation 172, responsive to the ending of the loop made up of operations 168 and 170, the avatars may be convened at a communication section of the teambuilding area. The communication section may include, for example, second subsection 78 of communication section 66 (shown in FIG. 3 and described above), a communication section designed specifically for method 164, and/or other communication sections. At operation 172, the users controlling the avatars may be encouraged to discuss their answers to the questions posed at operation 170. The discussion may include development of a shared team vision, a team goal or objective, and/or other team-based or individual concepts.

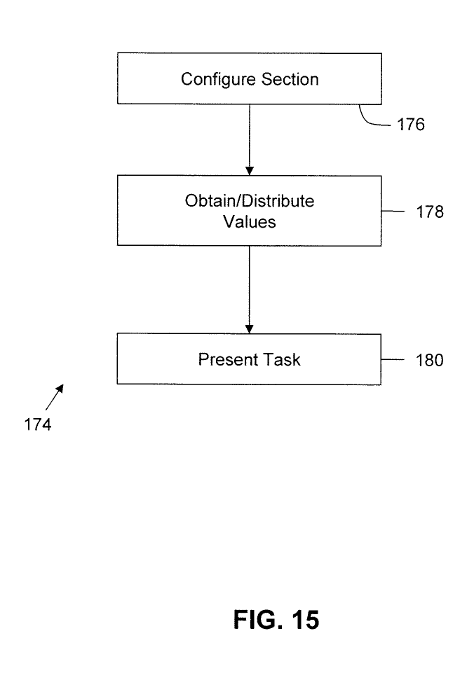

FIG. 15 illustrates a method 174 of providing a teambuilding activity in a virtual space to users associated with a real world entity. The virtual space may be configured to enhance innovation by the real world entity. The operations of method 174 presented below are intended to be illustrative. In some embodiments, method 174 may be accomplished with one or more additional operations not described, and/or without one or more of the operations discussed. Additionally, the order in which the operations of method 174 are illustrated in FIG. 15 and described below is not intended to be limiting.

In some embodiments, method 174 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 174 in response to instructions stored electronically on an electronic storage medium. The one or more processing devices may include one or more devices configured through hardware, firmware, and/or software to be specifically designed for execution of one or more of the operations of method 174. By way of example, one or more of the operations of 174 may be performed by a teambuilding module similar to or the same as teambuilding module 32 (shown in FIG. 1 and described above).

At an operation 176, a section of a teambuilding area may be configured to present a teambuilding activity to users controlling a group of avatars. Configuration of the activity section of the teambuilding area may include configuring content in which the group of avatars are presented with an objective or task that includes overcoming one or more obstacles. In some implementations, operation 176 may include configuring a section of a teambuilding area similar to or the same as section 72 (shown in FIG. 3 and described above).

At an operation 178, a set of values for the group of avatars may be obtained. The set of values may be selected by the users controlling the group of avatars, generated automatically, previously configured by a user or administrator associated with the entity, and/or obtained from other sources. The set of values may include one or more of teamwork, trust, collaboration, winning, efficiency, customer service, and/or other values.

At an operation 180, the content configured for the activity section at operation 176 may be presented to the users. This may include presenting views of the virtual space to the users in which the users control their avatars to accomplish the objective or task they have been presented with. The users may be required, prompted, reminded, or instructed to adhere to their obtained set of values in making decisions related to overcoming the obstacle(s) associated with the presented objective or task.

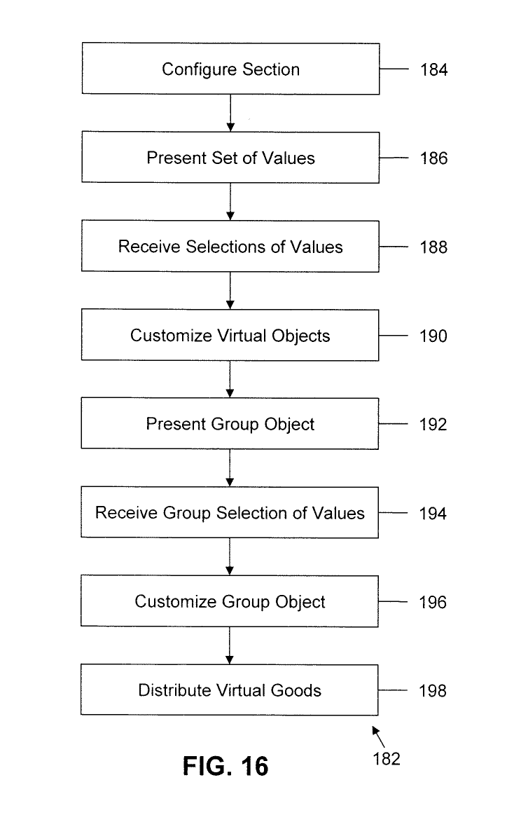

FIG. 16 illustrates a method 182 of providing a teambuilding activity in a virtual space to users associated with a real world entity. The virtual space may be configured to enhance innovation by the real world entity. The operations of method 182 presented below are intended to be illustrative. In some embodiments, method 182 may be accomplished with one or more additional operations not described, and/or without one or more of the operations discussed. Additionally, the order in which the operations of method 182 are illustrated in FIG. 16 and described below is not intended to be limiting. In some implementations, method 182 may be performed subsequent to method 174 (shown in FIG. 15 and described above) by the users that experienced method 174. However, this is not intended to be limiting, as method 182 may be valuable to users that have not experienced method 174 as a group and/or at all.

In some embodiments, method 182 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 182 in response to instructions stored electronically on an electronic storage medium. The one or more processing devices may include one or more devices configured through hardware, firmware, and/or software to be specifically designed for execution of one or more of the operations of method 182. By way of example, one or more of the operations of 182 may be performed by a teambuilding module similar to or the same as teambuilding module 32 (shown in FIG. 1 and described above).

At an operation 184, a section of a teambuilding area may be configured to present a team building activity to users controlling a group of avatars. Configuration of the activity section of the teambuilding area may include configuring views of a communication area that are similar to or the same as view 112 of fourth activity section 74 (shown in FIG. 6 and described above). In some implementations, operation 176 may include configuring a section of a teambuilding area similar to or the same as section 74 (shown in FIG. 3 and described above).

At an operation 186, a set of values may be presented to users controlling the group of avatars. The set of values may include values adhered to during performance of a previous task or objective (e.g., as in method 174 shown in FIG. 15 and described above), and/or other values.

At an operation 188, selections of values by individual users may be obtained. The selections of the values by the individual users may be to associate one or more selected values with the individual users separately from the group. The selections may be received via client platforms being used by the users to view views of the virtual space. If method 182 is performed subsequent to method 174, selection of values by the users may be informed by their experience during method 174.

At an operation 190, virtual objects associated with individual ones of the users may be created and/or customized to reflect the selection of values by the users received at operation 190. For example, the objects may include objects which appear in views of the virtual space as providing a seat and/or stand for an avatar. The object on which a given avatar sits and/or stands may be created and/or customized to reflect the values selected by the user controlling the given avatar. The customization may include text stating the selected values, symbols representing the given values, and/or other customizations.

At an operation 192, a group object may be presented in views of the virtual space to the users controlling the avatars. The group object may include, for example, a statue.

At an operation 194, selections of group values may be received. The group values may be selected from the set of values presented to the users at operation 186. The selection of group values may be a cooperative group effort amongst the users.

At an operation 196, the group object may be customized based on the selected values received at operation 194. The customization may take place in views of the section of the idea generation area of the virtual space as selection and/or unselection of values is ongoing (e.g., changing dynamically).

At an operation 198, virtual goods may be distributed to the users controlling the group of avatars based on the set of values selected for the group. The virtual goods may include representations of the group object.

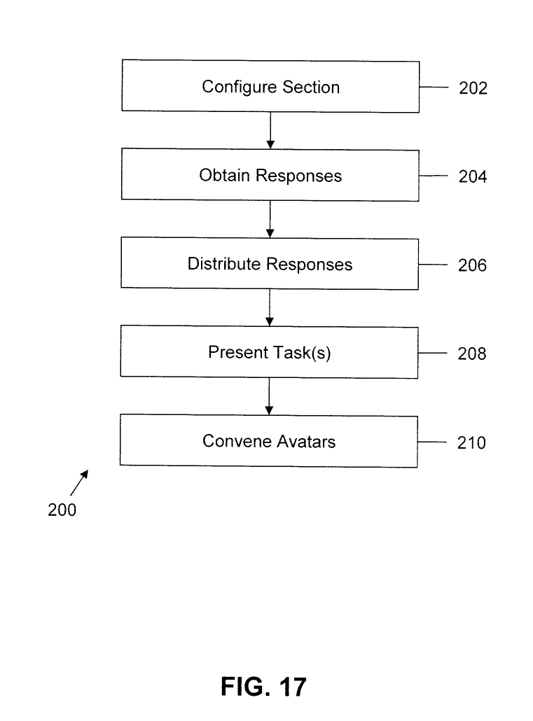

FIG. 17 illustrates a method 200 of providing a teambuilding activity in a virtual space to users associated with a real world entity. The virtual space may be configured to enhance innovation by the real world entity. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 17 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200. By way of example, one or more of the operations of 200 may be performed by a teambuilding module similar to or the same as teambuilding module 32 (shown in FIG. 1 and described above).

At an operation 202, a section of a teambuilding area may be configured to present a teambuilding activity to users controlling a group of avatars. Configuration of the activity section of the teambuilding area may include configuring content in which one or more tasks to be performed by individual avatars and/or subsets of the group of avatars. The section may be configure such that in views of the section presented to users controlling an avatar performing a task, avatars in the group of avatars not performing the task may be visible. The one or more tasks may require performance within a time period. For example, the views may be similar to or the same as view 120 of fifth activity section 75 (shown in FIG. 7 and described above). In some implementations, operation 202 may include configuring a section of a teambuilding area similar to or the same as section 75 (shown in FIG. 8 and described above).

At an operation 204, different responses and/or types of responses to the performance of the task(s) to be conveyed by avatars not performing the tasks may be obtained. The responses and/or types of responses may be obtained from storage, determined based on user or administrator selection, determined based on the configuration of the tasks, and/or otherwise obtained.

At an operation 206, the responses and/or types of responses to the performance of the task(s) may be distributed to the users controlling avatars in the group of avatars not performing the task(s). This may include distributing to a given user one or more levels of support and/or one or more timings corresponding to the levels of support. At the appropriate timings, the user may be prompted to control his avatar to convey the corresponding response and/or type of response, the avatar may be automatically controlled to convey the corresponding response and/or type of response, and/or the response and/or type of response may be otherwise distributed.

At an operation 208, the task(s) are performed by an avatar or subset of avatars from the group of avatars. In the views of the section of the teambuilding area presented to the user(s) controlling the avatar(s) performing the task(s), avatars from the group of avatars not performing the task(s) may be visible conveying the response and/or types of response distributed at operation 206.

At an operation 210, subsequent to performance of the task(s) the avatars may be convened at a communication section. The communication section may include, for example, second subsection 78 of communication section 66 (shown in FIG. 3 and described above), a communication section designed specifically for method 200, and/or other communication sections. At the communication section, the users may be led in a discussion of the impact of the observing avatars on the user(s) controlling the avatar(s) performing the task(s). The discussion and training on tools and techniques to alleviate stress may facilitate understanding by the users of the impact of group support on stress and/or job performance. This understanding may enhance performance by the group in working on problems and/or tasks in the future.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to provide a virtual space to a plurality of users associated with a real world entity, the system comprising:
one or more servers configured to host an instance of the virtual space such that the users can access the instance of the virtual space through client platforms in operative communication with the virtual space, the one or more servers comprising one or more physical processors configured to execute computer program modules, the computer program modules comprising:
a space module configured to serve information to the client platforms such that views of the instance of the virtual space are presented to the users on the client platforms;
an idea generation module configured such that the instance of the virtual space comprises an idea generation area, the idea generation area having therein content designed to facilitate cooperative generation of ideas by users for solutions related to the entity;
a collaboration module configured such that the instance of the virtual space comprises a collaboration area that is separate from the idea generation area, the collaboration area having therein content designed to facilitate interaction between users associated with the real world entity and users that are not associated with the real world entity; and
a teambuilding module configured such that the instance of the virtual space comprises a teambuilding area that is separate from the idea generation area and separate from the collaboration area, the teambuilding area having therein content designed to facilitate teambuilding between users associated with the entity.

2. The system of claim 1, wherein the space module is configured such that the views of the instance of the virtual space presented to the users on the client platforms include avatars controlled by the users via the client platforms.

3. The system of claim 1, wherein the idea generation module is configured such that the idea generation area comprises a first section and a second section separate from the first section, the idea generation module being configured such that views of the first section include visual representations of proposed solutions received from users via the client platforms, and such that views of the second section include a venue configured for simulations and/or role plays of real world interactions by avatars under control of the users via the client platforms.

4. The system of claim 3, wherein the visual representations of the proposed solutions include a surface visible in views of the first section having thereon text and/or markings generated by one or more of the users.

5. The system of claim 3, wherein the venue comprises a portion of the section that is visibly prominent in views of the second section, the visibly prominent potion of the section being configured for the performance of simulations and/or role plays thereon.

6. The system of claim 3, wherein the idea generation module is configured such that idea generation area further comprises a third section separate from the first section and the second section, the third section being configured such that users viewing the third section are provided with controls for creating design prototypes in the third section.

7. The system of claim 1, wherein the collaboration module is configured such that the collaboration area comprises a public section and a private section, wherein interactions between users viewing the private section are discernible only to a predefined group of users, and wherein the users between users viewing the public section are not restricted to a predefined group of users.

8. The system of claim 7, wherein the private section is a space within the collaboration area that is not visible to views of the collaboration area having points of view outside of the private section.

9. The system of claim 1, wherein the teambuilding module is configured such that the teambuilding area comprises content defining group activities' to be participated in by groups of users, the group activities being designed to build teamwork and cooperation between users within the groups of users.

10. The system of claim 1, wherein the teambuilding module is configured such that the teambuilding area includes a communication section, the communication section being configured such that views of the communication section include objects on which avatars under the control of users can sit.

11. The system of claim 10, wherein the teambuilding module is configured such that the objects on which avatars under the control of users can sit include objects that are customized for specific users.

12. A system configured to provide a virtual space to a plurality of users associated with a real world entity, the virtual space being configured to facilitate brainstorming by the users, the system comprising:
one or more servers configured to host an instance of the virtual space such that the users can access the instance of the virtual space through client platforms in operative communication with the virtual space, the one or more servers comprising one or more physical processors configured to execute computer program modules, the computer program modules comprising:
a space module configured to serve information to the client platforms such that views of the instance of the virtual space are presented to the users on the client platforms,
wherein the space module is configured such that the views of the instance of the virtual space presented to the users on the client platforms include avatars controlled by the users via the client platforms; and
an idea generation module configured such that the instance of the virtual space comprises an idea generation area having therein content designed to facilitate cooperative generation of ideas by users for solutions related to the entity,
wherein the idea generation module is configured such that the idea generation area comprises a first section and a second section separate from the first section, the idea generation module being further configured such that views of the first section include visual representations of proposed solutions received from users via the client platforms, and such that views of the second section include a venue configured for simulations of real world interactions and/or role playing by the avatars under control of the users via the client platforms.

13. The system of 12, wherein the visual representations of the proposed solutions include a surface visible in views of the first section having thereon text and/or markings generated by one or more of the users.

14. The system of claim 13, wherein the surface having thereon text and/or markings generated by one or more of the users comprises a representation of a sticky note or a representation of a whiteboard.

15. The system of claim 12, wherein the venue comprises a portion of the section that is visibly prominent in views of the second section, the visibly prominent potion of the section being configured for the performance of simulations and/or role plays thereon.

16. A system configured to provide a virtual space to a plurality of users associated with a real world entity, the virtual space being configured to facilitate private and public interactions between the users, the system comprising:
one or more servers configured to host an instance of the virtual space such that the users can access the instance of the virtual space through client platforms in operative communication with the virtual space, the one or more servers comprising one or more physical processors configured to execute computer program modules, the computer program modules comprising:
a space module configured to serve information to the client platforms such that views of the instance of the virtual space are presented to the users on the client platforms,
wherein the space module is configured such that the views of the instance of the virtual space presented to the users on the client platforms include avatars controlled by the users via the client platforms; and
a collaboration module configured such that the instance of the virtual space comprises an collaboration area having therein content designed to facilitate interaction between users that comprise presentation of ideas and collaboration,
wherein the collaboration module is configured such that the collaboration area comprises a public section and a private section, wherein interactions between users controlling avatars located within the private section are discernible only to a predefined group of users, the predefined group of users being controlled by one of the users that controls the private section, and wherein the interactions between users controlling avatars located within the public section are not restricted to a predefined group of users.

17. The system of claim 16, wherein the collaboration module is configured such that the private section is a space within the collaboration area that is not visible to views of the collaboration area having points of view outside of the private section.

18. The system of claim 16, wherein the collaboration module is configured such that sounds generated within the private section are not audible to users viewing the collaboration area from points of view outside of the private section.

19. A system configured to provide a virtual space to a plurality of users associated with a real world entity, the virtual space being configured to facilitate teambuilding by the users, the system comprising:
one or more servers configured to host an instance of the virtual space such that the users can access the instance of the virtual space through client platforms in operative communication with the virtual space, the one or more servers comprising one or more physical processors configured to execute computer program modules, the computer program modules comprising:
a space module configured to serve information to the client platforms such that views of the instance of the virtual space are presented to the users on the client platforms,
wherein the space module is configured such that the views of the instance of the virtual space presented to the users on the client platforms include avatars controlled by the users via the client platforms; and
a teambuilding module configured such that the instance of the virtual space comprises a teambuilding area having therein content designed to facilitate team building between users associated with the entity,
wherein the teambuilding module is configured such that the teambuilding area comprises content defining group activities to be participated in by groups of users, the group activities being designed to build teamwork and cooperation between users within the groups of users.

20. The system of claim 16, wherein the teambuilding module is configured such that the teambuilding area includes a communication section, the communication section being configured such that views of the communication section include objects on which avatars under the control of users can sit.

21. The system of claim 20, wherein the teambuilding module is configured such that the objects on which avatars under the control of users can sit include objects that are customized for specific users.

22. The system of claim 20, wherein the teambuilding modules is configured such that the teambuilding area comprises a plurality of sections configured such that individual sections have content therein defining activities to be performed by the avatars under the control of the users as a group.

23. The system of claim 22, wherein the sections comprise a first section configured for a group of avatars to travel through, the first section having therein a plurality of crossroads at which a plurality of potential paths for proceeding through the first section are presented to the group of avatars.

24. The system of claim 23, wherein the plurality of crossroads comprises a first crossroads at which a first potential path and a second potential path are presented to the group of avatars, and wherein the teambuilding module is configured (i) to receive selections from the users controlling the avatars in the group of avatars of the first potential path or the second potential path, (ii) to separate the group of avatars into a first subgroup of avatars for which users have selected the first potential path and a second subgroup of avatars for which users have selected the second potential path, and (iii) to present content associated with the first potential path in views of the instance of the virtual space to the first subgroup of avatars and content associated with the second potential path in views of the instance of the virtual space to the second subgroup of avatars.

25. The system of claim 24, wherein the teambuilding module is further configured such that, subsequent to the first subgroup of avatars and the second subgroup of avatars having proceeded along separate paths through the first section, the first subgroup of avatars and the second subgroup of avatars are reconvened in a second section of the teambuilding area and the users controlling the avatars discuss, via the media of the virtual space, the different choice they made at the first crossroads and their separate paths through the first section of the teambuilding area.

26. The system of claim 24, wherein the teambuilding module is further configured such that, subsequent to the first subgroup of avatars and the second subgroup of avatars having proceeded along separate paths through the first section, the users controlling the avatars are presented with virtual goods representing the choices of the avatars they controlled at the first crossroads.

27. The system of claim 22, wherein the teambuilding module is further configured such that the sections comprise a first section in which a group of avatars are conveyed along a path together, the teambuilding module being configured to present, at intervals, questions to the users controlling the avatars as a group.

28. The system of claim 27, wherein the teambuilding module is configured such that subsequent to the journey of the group of avatars through the first section, the group of avatars are disposed in a second section of the teambuilding area, the second section of the teambuilding area being configured to facilitate communication between the users controlling the avatars regarding the questions presented in the first section and their answers to the questions.

29. The system of claim 21, wherein the teambuilding module is configured such that the sections comprise a first section having therein a task to be performed by a group of avatars under the control of users via the client platforms, the teambuilding module being configured to assign a set of values to the group of avatars to which the group of avatars are to align during performance of the task.

30. The system of claim 29, wherein the teambuilding module is configured such that the sections comprise a second section, and such that subsequent to completion of the task, the group of avatars are conveyed to the second section of the teambuilding area to discuss performance of the task and the adherence to the assigned values.

31. The system of claim 30, wherein the teambuilding module is configured such that the second section of the teambuilding area comprises virtual objects representing different values, and such that avatars in the group of avatars are controllable to obtain selected ones of the virtual objects that represent values valued by the users controlling the avatars.

32. The system of claim 22, wherein the teambuilding module is configured such that the sections comprise a first section having therein a task to be completed by an avatar in a group of avatars, wherein the first section is configured such that avatars in the group of avatars not involved in performing the task are visible in views of the virtual space from a point of view corresponding to the avatar performing the task during performance of the task.

33. The system of claim 32, wherein the users controlling the avatars in the group of avatars not performing the task are prompted to control their avatars to convey specified responses in the performance of the task.

34. The system of claim 33, wherein the teambuilding module is configured such that the sections comprise a second section, and such that subsequent to performance of the task the group of avatars are convened in the second section and the users are prompted to communicate regarding the impact of the avatars not performing the task on the performance of the task.
